(19) United States
(12) Patent Application Publication
(10) Pub. No.: US 2014/0125463 A1
(43) Pub. Date: May 8, 2014

(54) CONTROL DEVICE HAVING A NIGHT LIGHT

(71) Applicant: Lutron Electronics Co., Inc., Coopersburg, PA (US)

(72) Inventors: Lawrence R. Carmen, JR., Bath, PA (US); Juha Mikko Hakkarainen, Palm Beach Gardens, FL (US); Timothy Mann, Quakertown, PA (US); Matthew Philip McDonald, Phoenixville, PA (US)

(73) Assignee: Lutron Electronics Co., Inc., Coopersburg, PA (US)

(21) Appl. No.: 14/155,810

(22) Filed: Jan. 15, 2014

Related U.S. Application Data
(63) Continuation-in-part of application No. 13/465,305, filed on May 7, 2012.
(60) Provisional application No. 61/485,885, filed on May 13, 2011.
(60) Provisional application No. 61/492,051, filed on Jun. 1, 2011.
(60) Provisional application No. 61/606,644, filed on Mar. 5, 2012.

(51) Int. Cl. G08C 17/02

(52) U.S. Cl. CPC G08C 17/02
USPC 340/12.5; 340/12.54

(57) ABSTRACT

A control device has a night light that allows the control device to be easily found when the control device is located in a dark space. The control device comprises a low-power night light circuit having an LED characterized by a normal current range. The night light circuit conducts an LED current through the LED in a first mode to illuminate the LED to a first level to provide a night light, where the LED current has a magnitude below the normal current range, such that the night light may be provided in a battery-powered remote control that has an acceptable battery lifetime. The night light circuit is configured to operate in a second mode to illuminate the LED to a second level greater than the first level to provide feedback. The LED current in the second mode has a magnitude within the normal current range of the LED.

### CROSS REFERENCES TO RELATED APPLICATIONS

This application is a continuation-in-part of commonly-assigned U.S. patent application Ser. No. 13/465,305, filed May 7, 2012, entitled CONTROL DEVICE HAVING A NIGHT LIGHT, which is a non-provisional application of commonly-assigned U.S. Provisional Application No. 61/485,885, filed May 13, 2011; U.S. Provisional Application No. 61/492,051, filed Jun. 1, 2011; and U.S. Provisional Application No. 61/606,644, filed Mar. 5, 2012; all entitled BATTERY-POWERED REMOTE CONTROL HAVING A NIGHT LIGHT. The entire disclosures of all of these applications are hereby incorporated by reference.

### BACKGROUND OF THE INVENTION

1. Field of the Invention

The present invention relates to a control device, such as a remote control, for a load control system for controlling the amount of power delivered from a source of alternating-current (AC) power to an electrical load, and more particularly, to a battery-powered remote control having a night light.

2. Description of the Related Art

Control systems for controlling the power delivered from an alternating-current (AC) power source to electrical loads, such as lights, motorized window treatments, and fans, are known. Such control systems often use the transmission of radio-frequency (RF) signals to provide wireless communication between the control devices of the system. The prior art lighting control systems include wireless load control devices, such as wall-mounted and table top dimmer switches. The dimmer switches included toggle actuators for turning controlled lighting loads on and off, and intensity adjustment actuators (e.g., rocker switches) for increasing and decreasing the intensities of the lighting loads. The dimmer switches also included one or more visual indicators, e.g., light-emitting diodes (LEDs), for providing feedback of the status of the lighting loads to users of the lighting control system.

The prior art wireless lighting control system also includes wireless remote controls, such as, wall-mounted and table top master controls (e.g., keypads) and car visor controls. The master controls of the prior art lighting control system each include a plurality of buttons and transmit RF signals to the dimmer switches to control the intensities of the controlled lighting loads. The master controls may also each include one or more visual indicators (i.e., LEDs) for providing feedback to the users of the lighting control system. The car visor controls are able to be clipped to the visor of an automobile and include one or more buttons for controlling the lighting loads of the lighting control system. An example of a prior art RF lighting control system is disclosed in commonly-assigned U.S. Pat. No. 5,905,442, issued on May 18, 1999, entitled METHOD AND APPARATUS FOR CONTROLLING AND DETERMINING THE STATUS OF ELECTRICAL DEVICES FROM REMOTE LOCATIONS, the entire disclosure of which is hereby incorporated by reference.

In order to make it easy for the users of the control system to find the control devices in a dark room, the control devices of prior art lighting control systems have often included night light features. For example, some prior art dimmer switches illuminated one or more of the visual indicators to a dim level when the controlled lighting load was off to provide a night light. In addition, some prior art dimmer switches dimly backlit one or more of the actuators when the controlled lighting load was off. However, if the dimmer switch is a “two-wire” device without a connection to the neutral side of the AC power source, the current required to illuminate the night light often needs to be conducted through the lighting load. When the magnitude of the current conducted through the lighting loads is too great, the lighting loads may flicker or provide otherwise poor performance.

Some master controls of the prior art load control system were powered from the AC power source and provided night light features, for example, by dimly illuminating one or more of the visual indicators. However, some of the wireless remote controls of the prior art lighting control systems were powered by batteries, which have limited lifetimes that are dependent upon the usage and the total current drawn from the batteries as well as how often the remote controls are used. The prior art battery-powered remote controls did not provide night lights, and simply illuminated the visual indicators for a period of time after one of the buttons of the remote control was actuated.

Therefore, there is a need for a low-power night light for use in battery-powered remote controls and two-wire load control devices.

### SUMMARY OF THE INVENTION

The present invention provides a night light for a control device that allows the control device to be easily found when the control device is located in a dark space. The night light is illuminated by a low-power night light circuit, such that the night light may be provided in a battery-powered remote control that has an acceptable battery lifetime (e.g., approximately three years). The night light comprises a lens that conducts the light from the night light circuit to the surface of the remote control and provides good off-angle viewing of the night light. In addition, the night light may be provided on a button of the remote control, for example, a button that causes a lighting load to be illuminated upon actuation. The lens of the night light may be raised from the surface of the button to provide tactile feedback to assist a user in locating the button that causes the lighting load to be illuminated when the control device is being operated in the dark space.

As described herein, a control device for use in a load control system for controlling an electrical load receiving power from a power source comprises: (1) a visual indicator; (2) an indicator circuit comprising an LED for illuminating the visual indicator, the indicator circuit operable to conduct an LED current through the LED to illuminate the LED, the LED having a normal operating current range; and (3) a controller coupled to the indicator circuit. The controller is configured to control the indicator circuit in a first mode to illuminate the LED to a first level to provide a night light. The LED current in the first mode has a magnitude below the normal operating current range. The controller is configured to control the indicator circuit in a second mode to illuminate the LED to a second level greater than the first level to provide feedback to a user of the control device. The LED current in the second mode has a magnitude within the normal operating current range of the LED.

Other features and advantages of the present invention will become apparent from the following description of the invention that refers to the accompanying drawings.

### BRIEF DESCRIPTION OF THE DRAWINGS

The invention will now be described in greater detail in the following detailed description with reference to the drawings in which:

FIG. 1 is a simple diagram of an RF lighting control system comprising a dimmer switch and a remote control;

FIG. 2 is an enlarged front perspective view of a remote control (e.g., the remote control of the lighting control system of FIG. 1);

FIG. 3 is an enlarged front view of the remote control of FIG. 2;

FIG. 4 is a left-side cross-sectional view of the remote control of FIG. 2 taken through the center of the remote control;

FIG. 5 is an alternate cross-sectional view of the remote control of FIG. 2 showing a profile of a preset button;

FIG. 6 is an enlarged perspective view of the preset button of the remote control of FIG. 2;

FIG. 7A is a front perspective view of a rear enclosure portion and a printed circuit board of the remote control of FIG. 2;

FIG. 7B is a rear perspective view of a front enclosure portion and a plurality of buttons of the remote control of FIG. 2;

FIG. 8 is a simplified block diagram of the electrical circuitry of a remote control (e.g., the remote control of FIG. 2);

FIG. 9A is an example schematic diagram of a night-light circuit of a remote control;

FIG. 9B is an alternative example schematic diagram of a night-light circuit;

FIG. 9C is another alternative example schematic diagram of a night-light circuit;

FIG. 10 is a left-side cross-sectional view of a remote control taken through the center of the remote control;

FIG. 11 is an enlarged cross-sectional view of a preset button of the remote control of FIG. 10;

FIG. 12 is a left-side cross-sectional view of a remote control taken through the center of the remote control;

FIG. 13 is an enlarged cross-sectional view of a preset button of the remote control of FIG. 12 taken through the center of the preset button;

FIG. 14 is an enlarged front view of a front surface of a light pipe of the preset button of FIG. 13 where the front surface has a textured surface formed by a plurality of concentric circular steps;

FIG. 15 is a partial enlarged cross-sectional view of the front surface of the light pipe of FIG. 14 taken through the center of the light pipe;

FIG. 16 is an enlarged front view of the front surface of the light pipe of the preset button of FIG. 13 where the front surface has a textured surface formed by a continuous helix shape;

FIG. 17 is an enlarged bottom perspective view of the preset button of FIG. 13 showing a shroud of the preset button in greater detail;

FIG. 18 is a front view of a two-button remote control having a night light;

FIG. 19 is a front view of a three-button remote control having a night light;

FIG. 20 is a front view of a four-button remote control having a night light;

FIG. 21 is a front view of a five-button remote control having a night light;

FIG. 22 is an enlarged perspective view of a raise button of a remote control (e.g., the four-button remote control of FIG. 20);

FIG. 23 is a right side cross-sectional view of the raise button of FIG. 22;

FIG. 24 is an enlarged perspective view of a raise button of a remote control (e.g., the four-button remote control of FIG. 20);

FIG. 25 is a right side cross-sectional view of the raise button of FIG. 24;

FIG. 26 is a perspective view of a wall-mountable a dimmer switch having a night light;

FIG. 27 is an example block diagram of a dimmer switch (e.g., the dimmer switch of FIG. 26);

FIG. 28 is an example block diagram of a dimmer switch;

FIG. 29 is an enlarged perspective view of a remote control having a dual-function visual indicator;

FIG. 30 is an example block diagram of a remote control;

FIG. 31 is an example schematic diagram of a dual-function indicator circuit of a remote control;

FIG. 32 is an alternate example schematic diagram of a dual-function indicator circuit of a remote control; and

FIG. 33 is another alternate example schematic diagram of a dual-function indicator circuit of a remote control.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

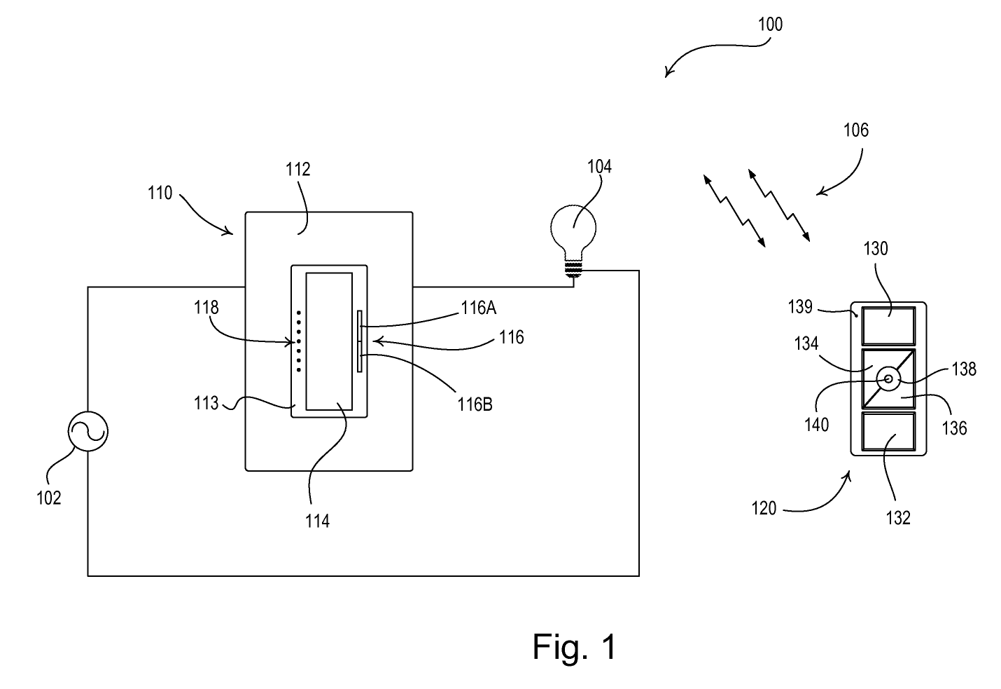

FIG. 1 is a simple diagram of an RF load control system 100 comprising a remotely-controllable load control device (e.g., a dimmer switch 110) and a battery-powered remote control 120. The dimmer switch 110 is coupled in series electrical connection between an AC power source 102 and an electrical lighting load 104 for controlling the amount of power delivered to the lighting load. The dimmer switch 110 is adapted to be wall-mounted in a standard electrical wallbox, and comprises a faceplate 112 and a bezel 113 received in an opening of the faceplate. Alternatively, the dimmer switch 110 could comprise a tabletop dimmer switch (i.e., connected between an electrical outlet and a tabletop or floor lamp) or a screw-in lamp dimmer switch (i.e., connected between a lamp socket of a tabletop or floor lamp and the actual light bulb). In addition, the RF lighting control system 100 may alternatively comprise another type of remotely-controllable load control device, such as, for example, a remotely-controllable electronic dimming ballast for a fluorescent lamp; a driver for a light-emitting diode (LED) light source; a screw-in luminaire that includes a light source and an integral load regulation circuit; a switching device for turning one or more appliances on and off; a plug-in load control device for controlling one or more plug-in loads; a motor control device for controlling a motor load, such as a ceiling fan or an exhaust fan; a drive unit for controlling a motorized window treatment, such as a roller shade or a drapery; and a central controller for controlling one or more electrical loads.

As shown in FIG. 1, the dimmer switch 110 comprises a toggle actuator 114 (i.e., a control button) and an intensity adjustment actuator 116 (e.g., a rocker switch). Actuations of the toggle actuator 114 toggle, i.e., alternately turn off and on, the lighting load 104. The dimmer switch 110 may be programmed with a preset lighting intensity, such that the dimmer switch is operable to control the intensity of the lighting load 104 to the preset intensity when the lighting load is turned on by an actuation of the toggle actuator 114. Actuations of an upper portion 116A or a lower portion 116B of the intensity adjustment actuator 116 respectively increase or decrease the amount of power delivered to the lighting load 104 and thus increase or decrease the intensity of the lighting load. A plurality of visual indicators 118, e.g., light-emitting diodes (LEDs), are arranged in a linear array on the left-side of the bezel 113 and are illuminated to provide feedback of the present intensity of the lighting load 104. Specifically, the dimmer switch 110 illuminates one of the plurality of visual indicators 118, which is representative of the present light intensity of the lighting load 104. An example of a dimmer switch having a toggle actuator 114, an intensity adjustment actuator 116, and a linear array of visual indicators 118 is described in greater detail in commonly-assigned U.S. Pat. No. 5,248,919, issued Sep. 29, 1993, entitled LIGHTING CONTROL DEVICE, the entire disclosure of which is hereby incorporated by reference.

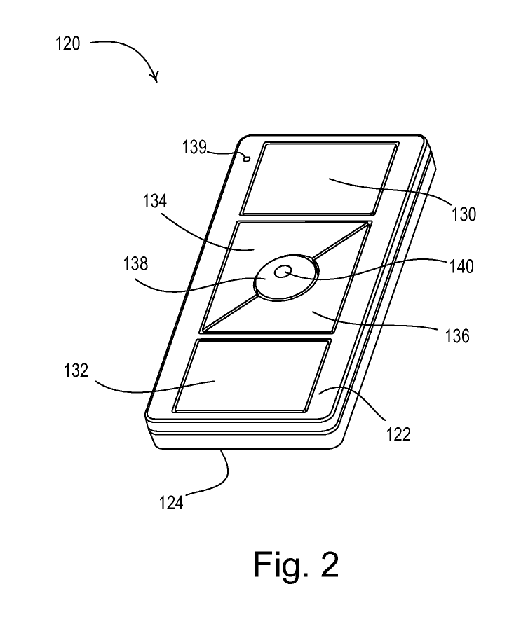

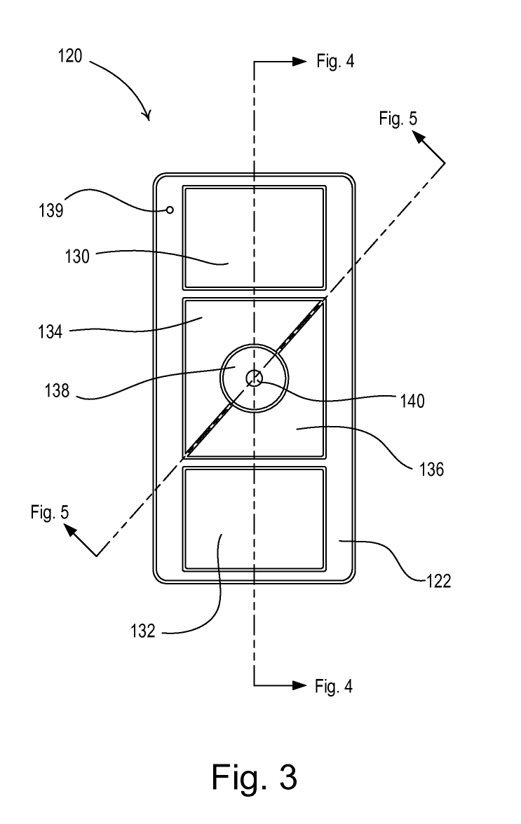

FIG. 2 is an enlarged perspective view and FIG. 3 is an enlarged front view of the remote control 120. The remote control 120 comprises a housing that includes a front enclosure portion 122 and a rear enclosure portion 124. The remote control 120 further comprises a plurality of control elements (e.g., an on button 130, an off button 132, a raise button 134, a lower button 136, and a preset button 138) that are provided in openings of the front enclosure portion. The remote control 120 also comprises a visual indicator 139, which is illuminated in response to the actuation of one of the buttons 130-138. The structure of a remote control, such as the remote control 120, is described in greater detail in commonly-assigned U.S. patent application Ser. No. 12/399,126, filed Mar. 6, 2009, entitled WIRELESS BATTERY-POWERED REMOTE CONTROL HAVING MULTIPLE MOUNTING MEANS, the entire disclosure of which is hereby incorporated by reference.

The remote control 120 transmits packets (i.e., digital messages) via RF signals 106 (i.e., wireless transmissions) to the dimmer switch 110 in response to actuations of any of the actuators. A packet transmitted by the remote control 120 includes, for example, a preamble, a serial number associated with the remote control, and a command (e.g., on, off, preset, etc.). During a setup procedure of the RF load control system 100, the dimmer switch 110 is associated with one or more remote controls 120. The dimmer switch 110 is then responsive to packets containing the serial number of the remote control 120 to which the dimmer switch is associated. The dimmer switch 110 turns the lighting load 104 on and off in response to actuations of the on button 130 and the off button 132, respectively. The dimmer switch 110 raises and lowers the intensity of the lighting load 104 in response to actuations of the raise button 134 and the lower button 136, respectively. The dimmer switch 110 controls the lighting load 104 to the preset intensity in response to actuations of the preset button 138. The dimmer switch 110 may be associated with the remote control 120 during a manufacturing process of the dimmer switch and the remote control, or after installation of the dimmer switch and the remote control. The configuration and operation of the RF load control system 100 is described in greater detail in commonly-assigned U.S. Pat. No. 7,573,208, issued Aug. 22, 1009, entitled METHOD OF PROGRAMMING A LIGHTING PRESET FROM A RADIO-FREQUENCY REMOTE CONTROL, the entire disclosures of which are hereby incorporated by reference.

The remote control 120 further comprises a night light 140 in the center of the preset button 138. The night light 140 is illuminated to a dim level at all times to allow a user to easily locate the remote control 120 in a dark room. For example, if the remote control 120 is mounted to a wall in a hotel room, an occupant of the hotel room may easily find the remote control after entering the room in the dark. The night light 140 will be described in greater detail below.

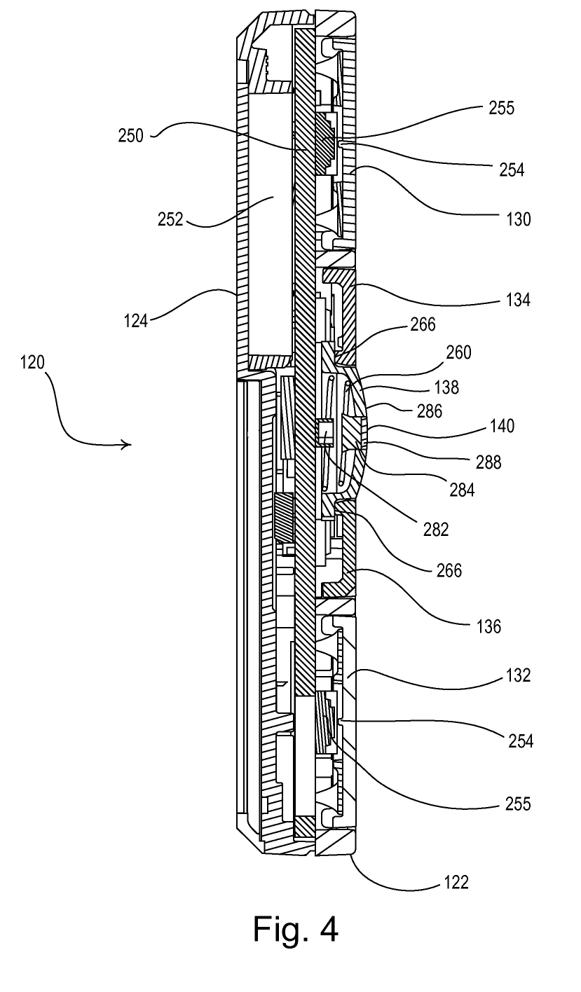

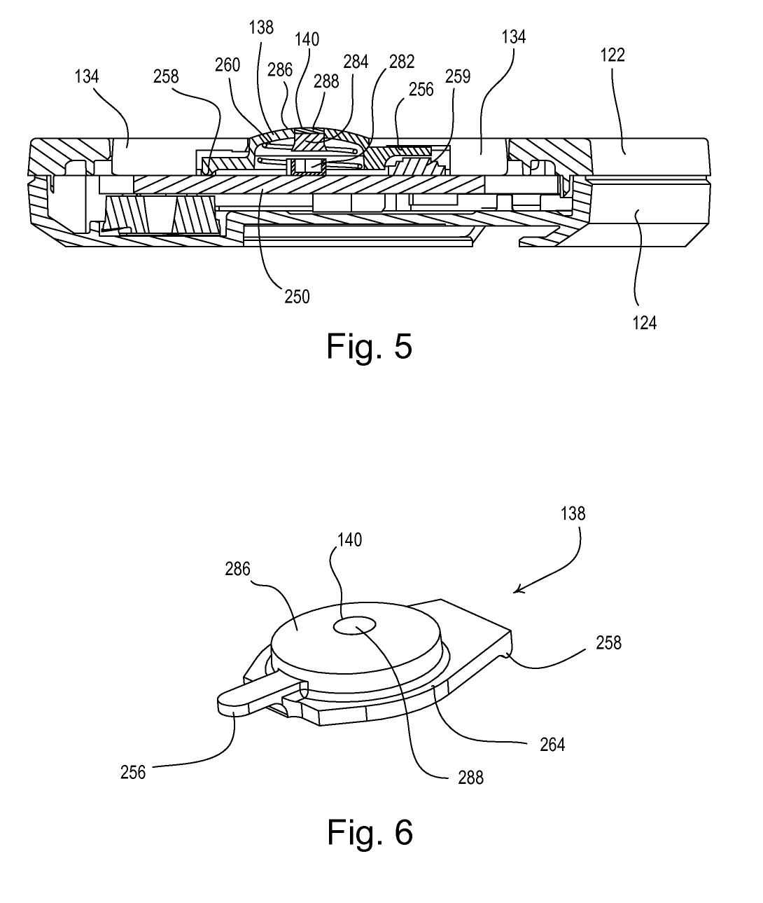

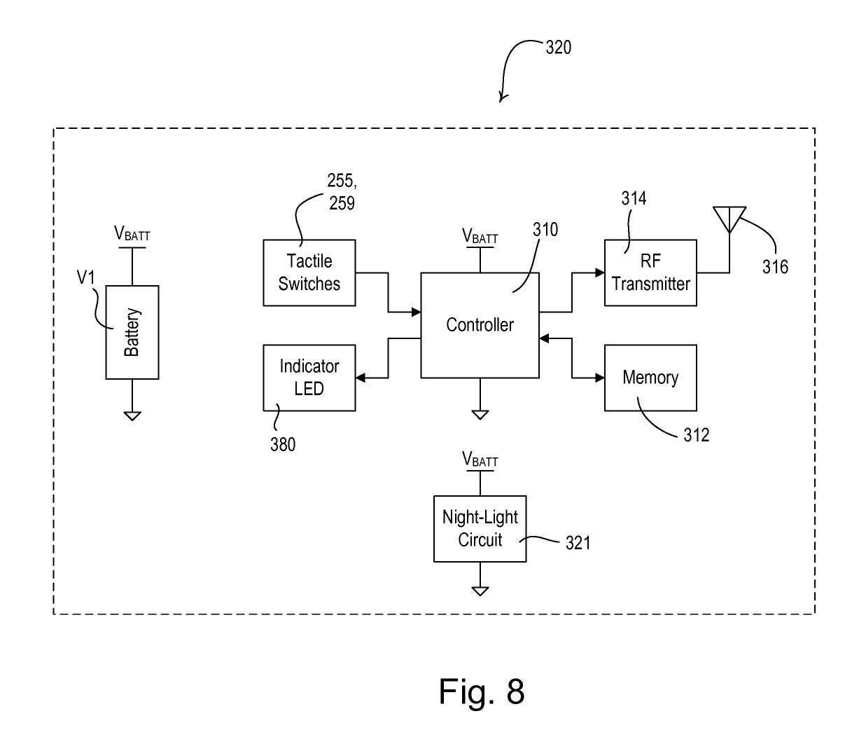

FIG. 4 is a left-side cross-sectional view of the remote control 120 taken through the center of the remote control as shown in FIG. 3. FIG. 5 is an alternate cross-sectional view of the remote control 120 (taken through the diagonal line in FIG. 3) showing the profile of the preset button 138 in greater detail. FIG. 6 is an enlarged perspective view of the preset button 138. The electrical circuitry of the remote control 120 is mounted to a printed circuit board (PCB) 250, which is fixedly housed between the front enclosure portion 122 and the rear enclosure portion 124. A battery V1 (FIG. 8) is housed in a battery enclosure portion 252 and provides a battery voltage V_{BATT} (e.g., approximately 3V) for powering the electrical circuitry of the remote control 120. For example, the battery V1 may comprise part number CR2032, manufactured by Panasonic Corporation.

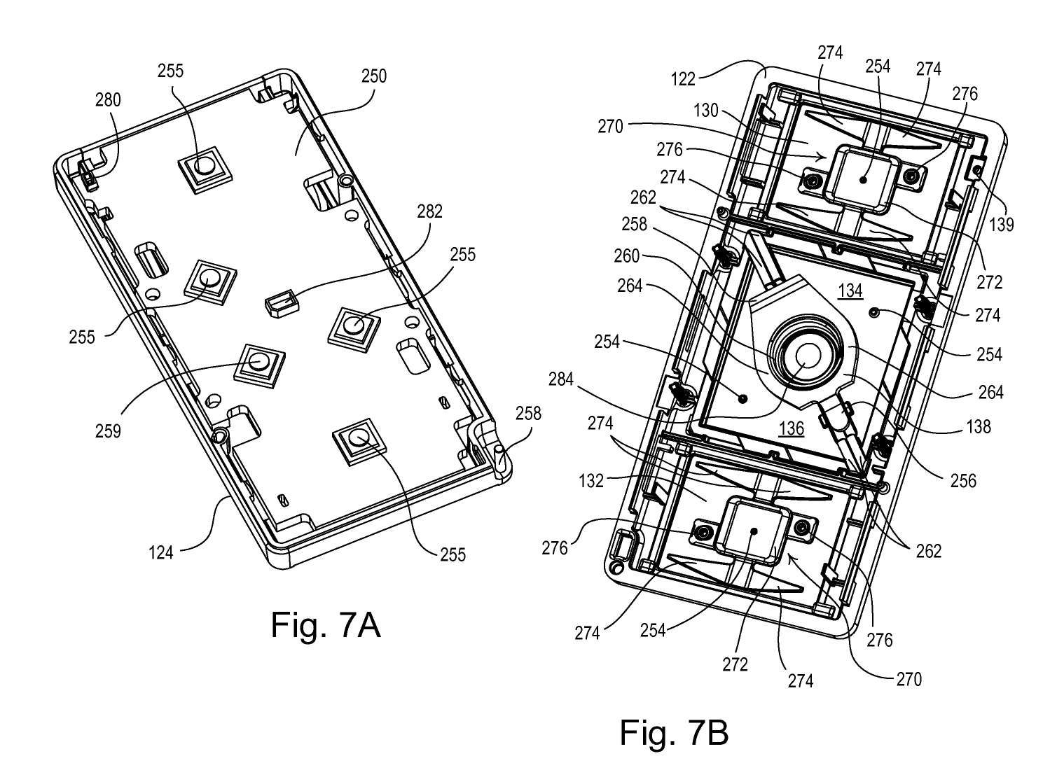

FIGS. 7A and 7B show the remote control 120 in a partially-disassembled state. Specifically, FIG. 7A is a front perspective view of the rear enclosure portion 124 and the PCB 250, and FIG. 7B is a rear perspective view of the front enclosure portion 122 and the buttons 130-138. The on button 130, the off button 132, the raise button 134, and the lower button 136 comprise actuation posts 254 for actuating mechanical tactile switches 255 mounted on the PCB 250. As shown in FIG. 6, the preset button 138 comprises a switch actuation portion 256 and a pivoting portion 258. The remote control 120 comprises a preset button return spring 260, which may comprise, for example, a coil spring having a first end contacting the PCB 250 and a second end contacting the preset button 138, such that the return spring is positioned between the PCB and the preset button (as shown in FIG. 4). When the preset button 138 is actuated, the preset button 138 pivots about the pivoting portion 258 and the switch actuation portion 256 actuates a mechanical tactile switch 259 on the PCB 250. After the preset button 138 is released, the preset button return spring 260 operates to return the preset button to an idle position.

The raise button 134 and the lower button 136 comprise pivoting structures 262 that rest on the PCB 250 (as shown in FIG. 4), such that the raise and lower buttons 134, 136 are operable to pivot about the pivoting structures when the buttons are actuated. The preset button return spring 260 (that is positioned below the preset button 138) also operates to return the raise and lower buttons 134, 136 to their respective idle positions after an actuation of either of the raise or lower buttons. The preset button 138 comprises flanges 264 on which respective edges 266 of the raise and lower buttons 134, 136 rest (as shown in FIG. 4). When, for example, the raise button 134 is depressed, the raise button pivots about the respective pivoting structure 262 and the actuation post 254 of the raise button actuates the mechanical tactile switch 254 under the raise button. At this time, the edge 266 of the raise button 134 contacts the respective flange 264 of the preset button 138 and the preset button return spring 260 does compress slightly. When the raise button 134 is subsequently released, the preset return spring 260 causes the flange 264 of the preset button 138 to contact the respective edge 266 of the raise button 134 to force the raise button back to the idle position. Thus, the single preset button return spring 260 is operable to cause all of the preset button 138, the raise button 134, and the lower button 136 to return to their respective idle positions, which is described in greater detail in commonly-assigned U.S. patent application Ser. No. 12/643,126, filed Dec. 21, 2009, entitled CONTROL DEVICE HAVING A SINGLE RETURN SPRING FOR MULTIPLE BUTTONS, the entire disclosure of which is hereby incorporated by reference.

The remote control 120 further comprises return springs 270 connected to the bottom sides of the on button 130 and the off button 132 (as shown in FIG. 7B). The springs 270 each comprise square base portions 272 that are positioned adjacent to the bottom sides of the on button 130 and the off button 132. The base portions 272 have openings for receiving the corresponding mechanical switches 255 on the PCB 250, such that the actuation posts 254 can actuate the mechanical switches when the on button 130 and the off button 132 are actuated. The return springs 270 comprise legs 274 that extend from the base portions 272 to contact the PCB 250 (as shown in FIG. 4). When the on button 130 or the off button 132 is pressed, the legs 274 flex allowing the button to be depressed and the respective actuation post 254 to actuate the mechanical switch 255. When the respective button 130, 132 is then released, the return spring 270 forces the button away from the PCB 250 (i.e., returns the button to an idle position). The springs 270 have attachment openings 276 that are, for example, heat-staked to the bottom sides of the on button 130 and the off button 132.

The remote control 120 further comprises an indicator LED 280 for illuminating the visual indicator 139 and a night-light LED 282 for illuminating the night light 140. The night-light LED 282 is mounted on the PCB 250 immediately behind the night light 140, such that the preset button return spring 260 surrounds the night-light LED as shown in FIGS. 4 and 5. For example, the night-light LED 282 may comprise a green LED, such as part number AA3021ZGS-G, manufactured by Kingbright Corporation, which has a normal rated operating current of approximately 20 mA. Since the preset button 138 is made from an opaque material, such as colored plastic, the preset button comprises a translucent light pipe 284 positioned between the night light 140 and the night-light LED 282. The light pipe 284 operates to conduct light from the night-light LED 282 to a front surface 286 of the preset button 138. The preset button 138 also comprises a diffusive element 288 adjacent the front surface 286 of the preset button, and overlaying the light pipe 284.

FIG. 8 is a simplified block diagram of the electrical circuitry of a remote control 320 (e.g., the remote control 120 of FIGS. 1-7B). The remote control 320 comprises a controller 310, which is operable to receive inputs from mechanical tactile switches (e.g., the mechanical tactile switches 255, 259) and to control an indicator LED 380 (e.g., the indicator LED 280). The remote control 320 comprises a memory 312 for storage of the unique device identifier (e.g., a serial number) of the remote control. The remote control 320 further includes an RF transmitter 314 coupled to the controller 310 and an antenna 316, which may comprise, for example, a loop antenna. The controller 310, the memory 312, the RF transmitter 314, and other electrical circuitry of the remote control 320 are powered from the battery voltage V_{BATT} produced by the battery V1. The remote control 320 further comprises a night-light circuit 321 that includes a night-light LED (e.g., the night-light LED 282 of the remote control 120 shown in FIG. 4).

In response to an actuation of a button (e.g., one of the on button 130, the off button 132, the raise button 134, the lower button 136, and the preset button 138), the controller 310 causes the RF transmitter 314 to transmit a packet, e.g., to the dimmer switch 110 via the RF signals 106. Alternatively, the RF receiver of the dimmer switch 110 and the RF transmitter 314 of the remote control 320 could both comprise RF transceivers to allow for two-way RF communication between the remote control and the dimmer switch. An example of a two-way RF lighting control systems is described in greater detail in commonly-assigned U.S. patent application Ser. No. 12/033,223, filed Feb. 19, 2008, entitled COMMUNICATION PROTOCOL FOR A RADIO-FREQUENCY LOAD CONTROL SYSTEM, the entire disclosure of which is hereby incorporated by reference.

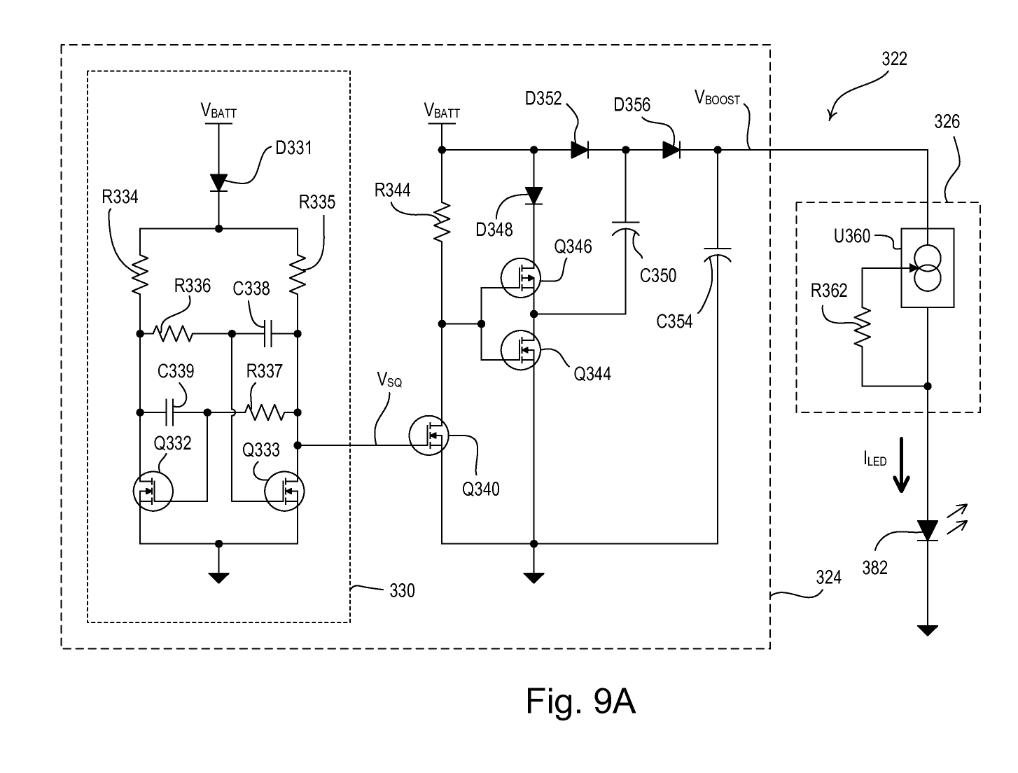

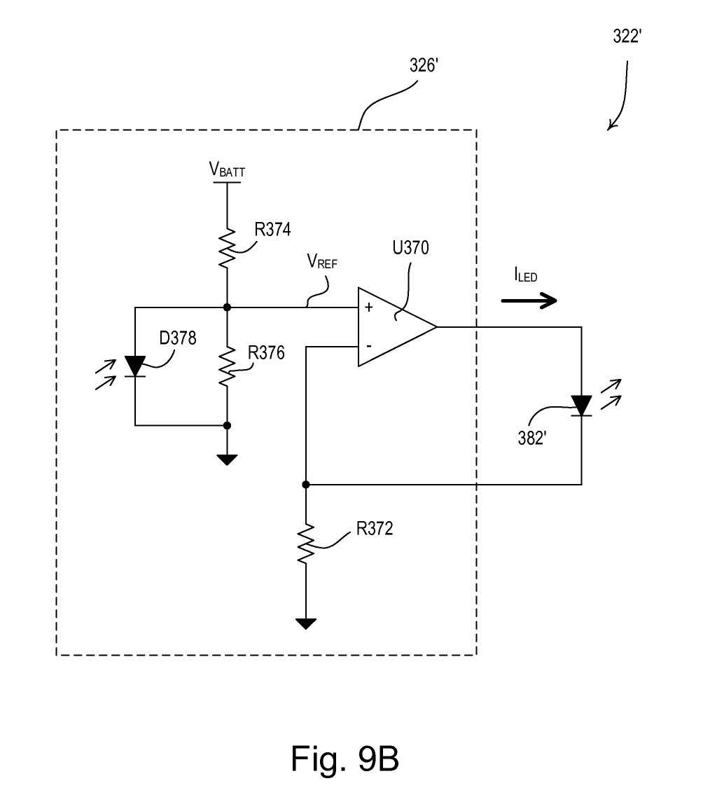

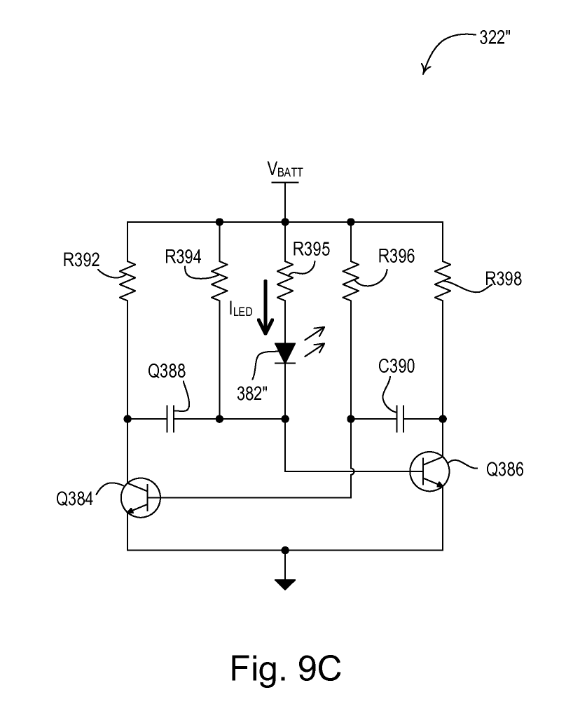

FIG. 9A is an example schematic diagram of a night-light circuit 322 (e.g., the night-light circuit 321 of the remote control 320). The night-light circuit 322 includes a charge pump circuit 324 and a constant current source circuit 326. The charge pump circuit 324 generates a boosted voltage V_{BOOST} (e.g., approximately five volts) for driving a night-light LED 382 (e.g., the night-light LED 282), and the constant current source circuit 326 conducts a constant LED current I_{LED} through the night-light LED for constantly and dimly illuminating the night-light LED.

The charge pump circuit 324 comprises a multivibrator circuit 330 for generating an oscillating square-wave voltage V_{SQ}. The multivibrator circuit 330 includes a diode D331, two N-channel metal-oxide semiconductor field-effect transistors (FETs) Q332, Q333 (e.g., part number NTZD3155C manufactured by ON Semiconductor) that each have, for example, a low gate threshold voltage (e.g., approximately 0.45 to 1 volt). The multivibrator circuit 330 also comprises two resistors R334, R335, which are coupled in series with the FETs Q332, Q333, respectively, and have, for example, resistances of approximately 10 MΩ The multivibrator circuit 330 further comprises two resistors R336, R337 (e.g., each having a resistance of approximately 10 MΩ) and two capacitors C338, C339 (e.g., each having a capacitance of approximately 0.01 μF). The series combination of the resistor R336 and the capacitor C338 and the series combination of the resistor R337 and the capacitor C339 are coupled in between the junction of the FET Q332 and the resistor R334 and the junction of the FET Q333 and the resistor R335. The multivibrator circuit 330 operates to render the FETs Q332, Q333 conductive on a complementary basis (i.e., the FET Q332 is conductive when the FET Q333 is non-conductive, and vice versa). The square-wave voltage V_{SQ} is generated across the FET Q333, such that when the FET Q333 is conductive, the square-wave voltage V_{SQ} is driven low towards circuit common, and when the FET Q333 is non-conductive, the square-wave voltage V_{SQ} is pulled high towards the battery voltage V_{BATT}.

The charge pump circuit 324 comprises an N-channel FET Q340 having a drain-source channel coupled between the battery voltage V_{BATT} and circuit common through a resistor R344 (e.g., having a resistance of approximately 3.3 MΩ). The gate of the FET Q340 is coupled to the multivibrator circuit 330 for receiving the square-wave voltage V_{SQ}. The charge pump circuit 324 further comprises an N-channel FET Q344 and a P-channel FET Q346 having drain-source channels coupled in series between the battery voltage V_{BATT} and circuit common through a diode D348. The gates of the FETs Q344, Q346 are coupled together to the junction of the FET Q340 and the resistor R344. The FETs Q340, Q344, Q346 also may have low gate threshold voltages.

When the square-wave voltage V_{SQ} is pulled low towards circuit common, the FET Q340 is rendered non-conductive, such that the gates of the FETs Q344, Q346 are pulled up towards the battery voltage V_{BATT} through the resistor R344. Accordingly, the P-channel FET Q346 is rendered non-conductive and the N-channel FET Q344 is rendered conductive, such that a capacitor C350 (which has a capacitance of, for example, approximately 47 μF) is able to charge through a diode D352 to a voltage equal to approximately the battery voltage V_{BATT} minus a “diode drop” (i.e., the forward voltage V_{E} of the diode D352). When the square-wave voltage V_{SQ} is pulled high towards the battery voltage V_{BATT}, the N-channel FET Q344 is rendered non-conductive and the P-channel FET Q346 is rendered conductive, such that the capacitor C350 is able to discharge into a capacitor C354 (e.g., having a capacitance of approximately 10 μF) through a diode D356 to generate the boosted voltage V_{BOOST} across the capacitor C354. Since the P-channel FET Q346 is conductive and the capacitor C350 is coupled in series with the diode D348 when the capacitor C350 is discharging into the capacitor C354, the boosted voltage V_{BOOST} has a magnitude approximately equal to twice the battery voltage V_{BATT} minus three diodes drops (i.e., V_{BOOST}=2·V_{BATT}−3·V_{F}).

More particularly, when the FET Q344 is turned on, the capacitor C350 charges to the battery voltage V_{BATT} less the diode drop of the diode D352. When the FET Q346 turns on, the negative terminal of the capacitor C350 charges to the battery voltage V_{BATT} less the diode drop of the diode D348. The positive terminal of the capacitor C350 is then at twice the battery voltage V_{BATT} less the two diode drops of the diodes D348, D352. The capacitor C350 discharges into the capacitor C354, which is charged to twice the battery voltage V_{BATT} minus the three diode drops of the diodes D348, D352, D356.

The constant current source circuit 326 receives the boosted voltage V_{BOOST} from the charge pump circuit 324 and conducts the constant LED current I_{LED} through the night-light LED 382. The constant current source circuit 326 comprises a current source integrated circuit (IC) U360, for example, a three-terminal adjustable current source IC, such as part number LM334, manufactured by National Semiconductor Corporation. A resistor R362 is coupled to a current-set input of the current source IC U360 for setting the constant magnitude of the LED current I_{LED}. For example, the resistor R362 may have a resistance of approximately 46.4 kΩ, such that the constant LED current I_{LED} has a magnitude of approximately 1.5 μA. Accordingly, the magnitude of the constant LED current I_{LED} is several orders of magnitude (e.g., approximately three orders of magnitude) less than the normal rated operating current of the night-light LED 382 (i.e., approximately 20 mA). By driving the night-light LED 382 with the small constant LED current I_{LED} of 1.5 μA, the night-light LED 382 is operable to illuminate the night light 140 to a level that is visible by the human eye in a dark room (e.g., just barely visible). The magnitude of the constant LED current I_{LED} is small enough that the battery V1 has an acceptable lifetime (e.g., approximately three years).

Alternatively, the night-light circuit 322 could be implemented such that a controller (e.g., the controller 310) could control the night-light circuit to pulse-width modulate the LED current I_{LED}, such that the LED current I_{LED} has an average magnitude of approximately 1.5 μIA. The peak magnitudes of the pulses of the pulse-width modulated LED current I_{LED} could be in a range where the night-light LED 382 puts out more lumens per watt. Accordingly, when the LED current I_{LED} is pulse-width modulated, the night-light LED 382 may be illuminated brighter for the same average LED current.

FIG. 9B is an alternate example schematic diagram of a night-light circuit 322′. The night-light circuit 322′ comprises a constant current source circuit 326′ for conducting a constant LED current I_{LED} through a night-light LED 382′ (e.g., the night-light LED 282) to constantly and dimly illuminate the night-light LED. The constant current source circuit 326′ comprises an operational amplifier (op amp) U370 having an inverting input coupled to circuit common through a resistor R372 (e.g., having a resistance of approximately 130 kΩ). The constant current source circuit 326′ further comprises two resistors R374, R376, which are coupled in series between the battery voltage V_{BATT} and circuit common, and have resistances of, for example, approximately 5.1 MΩ and 390 kΩ, respectively. A reference voltage V_{REF} (e.g., approximately 0.2 V) is generated at the junction of the resistors R374, R376 and is coupled to a non-inverting input of the op amp U370. The night-light LED 382′ is coupled between an output of the op amp U370 and the junction of the inverting input and the resistor R372. The op amp U370 conducts the LED current I_{LED} through the night-light LED 382′, such that a voltage approximately equal to the reference voltage V_{REF} is generated across the resistor R372. Accordingly, the op amp U370 maintains the magnitude of the LED current I_{LED} approximately constant, e.g., at approximately 1.5 μA. Since the magnitude of the LED current I_{LED} is dependent upon the reference voltage V_{REF}, which is a scaled version of the battery voltage V_{BATT}, fluctuations in the magnitude of the battery voltage V_{BATT} do not result in particularly large changes in the magnitude of the LED current I_{LED}, and thus the intensity of the night-light LED 382′.

In addition, the night-light circuit 322′ may also comprise a photodiode D378 coupled in parallel with the resistor R376 having an anode coupled to the non-inverting input of the op amp U370 and a cathode coupled to circuit common. The photodiode D378 may be responsive to the ambient light level around the remote control 120, such that as the ambient light level increases, the photodiode conducts more current, thus reducing the magnitude of the reference voltage V_{REF} at the non-inverting input of the op amp U370 and the magnitude of the LED current I_{LED}. Accordingly, when there is more light around the remote control 120 and the night light 140 does not need to be very bright, the night-light circuit 322′ would reduce the intensity of the night-light LED 382′.

FIG. 9C is another alternate example schematic diagram of a night-light circuit 322″. The night-light circuit 322″ comprises an astable multivibrator circuit for conducting a pulse-width modulated LED current I_{LED} through a night-light LED 382″ (e.g., the night-light LED 282) to constantly and dimly illuminate the night-light LED. For example, the night-light LED 382″ may comprise a green LED, such as part number AA3021-PL59, manufactured by Kingbright Corporation, which has a normal rated operating current of approximately 2 mA. The astable multivibrator circuit of the night-light circuit 322″ comprises first and second NPN bipolar junction transistors Q384, Q386. A first capacitor C388 is coupled between the collector of the first transistor Q384 and the base of the second transistor Q386 and may have a capacitance of, for example, approximately 200 pF. A second capacitor C390 is coupled between the collector of the second transistor Q386 and the base of the first transistor Q384 and may have a capacitance of, for example, approximately 100 pF. The collector of the first transistor Q384 is coupled to the battery voltage V_{BATT} through a resistor R392 (e.g., having a resistance of approximately 1.2 MΩ). The base of the second transistor Q386 is coupled to the battery voltage V_{BATT} through a resistor R394 (e.g., having a resistance of approximately 2.5 MΩ). The base of the first transistor Q384 is coupled to the battery voltage V_{BATT} through a resistor R396 (e.g., having a resistance of approximately 7.5 MΩ). The collector of the second transistor Q386 is coupled to the battery voltage V_{BATT} through a resistor R398 (e.g., having a resistance of approximately 2 MΩ). The night-light LED 382″ is coupled in series with a resistor R395 (e.g., having a resistance of approximately 400 kΩ) with the series combination of the night-light LED 382″ and the resistor R395 coupled between the battery voltage V_{BATT} and the base of the second transistor Q386.

When the battery voltage V_{BATT} is first applied to the astable multivibrator circuit of the night-light circuit 322″ shown in FIG. 9C, the magnitude of the voltage at the base of the second transistor Q386 increases faster than the magnitude of the voltage at the base of the first transistor Q384. At this time, the magnitude of the voltage at the collector of the second transistor Q386 increases quicker than the magnitude of the voltage at the base of the first transistor Q384, such that the capacitor C390 charges. The second transistor Q386 is rendered conductive before the first transistor Q384, such that the collector of the second transistor Q386 is pulled rapidly down towards circuit common and the base of the first transistor Q384 is driven below circuit common (because of the voltage developed across the capacitor C390, which cannot change instantaneously).

When the second transistor Q386 is conductive, the voltage at the collector of the first transistor Q384 increases with respect to the base of the second transistor Q386, such that the capacitor C388 charges. The voltage at the base of the first transistor C384 continues to increase in magnitude until the first transistor is rendered conductive. Accordingly, the collector of the first transistor Q384 is pulled down towards circuit common and the base of the second transistor Q386 is driven below circuit common (because of the voltage developed across the capacitor C388), such that the second transistor Q386 is rendered non-conductive. When the first transistor Q384 is conductive, the night-light LED 382″ is illuminated and conducts the LED current I_{LED} through the resistor R395. At this time, the magnitude of the voltage at the base of the second transistor Q386 increases until the second transistor is rendered conductive, and the process repeats with the first and second transistor Q384, Q386 being alternately rendered conductive. For example, the pulse-width modulated LED current I_{LED} may be characterized by a duty cycle of approximately 10% and an operating frequency of approximately 1.2 kHz, such that the intensity of the night light LED 382″ appears constant to the human eye.

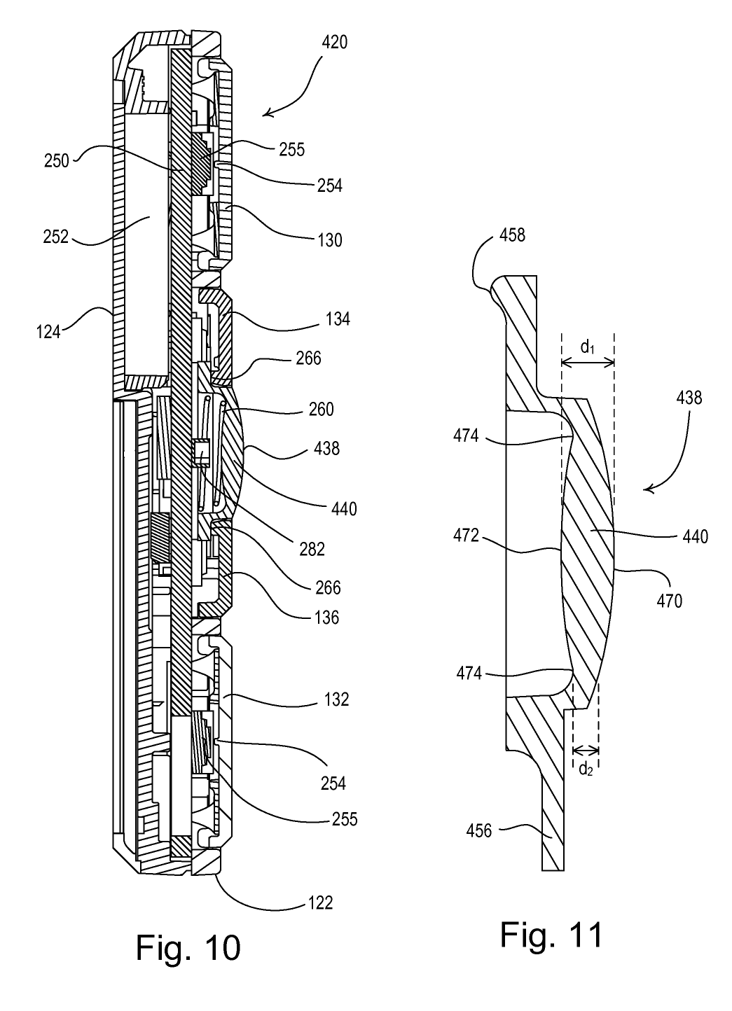

FIG. 10 is a left-side cross-sectional view of an alternative example of a remote control 420 taken through the center of the remote control. FIG. 11 is an enlarged cross-sectional view of a preset button 438 of the remote control 420 (taken through the diagonal line as shown in FIG. 3). When actuated, the preset button 438 pivots about a pivoting portion 458, such that a switch actuation portion 456 actuates a mechanical tactile switch (e.g., the mechanical tactile switch 259 on the PCB 250). As shown in FIGS. 10 and 11, the preset button 438 comprises a “lensfuser” portion 440 (i.e., a lens and diffuser element) that has a curved front surface 470 and a curved rear surface 472 and is located immediately in front of a night-light LED (e.g., the night-light LED 282). The lensfuser portion 440 operates as both a lens and diffuser to thus conduct the light emitted by the night-light LED 282 to the front surface 470 and provide a substantially uniform distribution of light on the front surface. The lensfuser portion 440 is coupled to the switch actuation portion 456 and the pivoting portion 458 via rounds 474 and may be made from, for example, polycarbonate with a diffusive filler, such as, titanium dioxide. The radius of the front surface 470 (e.g., approximately 0.583 inch) is smaller than the radius of the rear surface 472 (e.g., approximately 0.664 inch). A distance d1 between the front surface 470 and the rear surface 472 near the center of the lensfuser portion 440 (e.g., approximately 0.021 inch) is greater than a distance d2 between the front surface and the rear surface adjacent the rounds 474 (e.g., approximately). Accordingly, there is more of the diffusive filler located between the front surface 470 and the rear surface 472 near the center of the lensfuser portion 440 to provide for more diffusion of the light near the center of the preset button 438, where the light from the night-light LED 282 tends to be brighter.

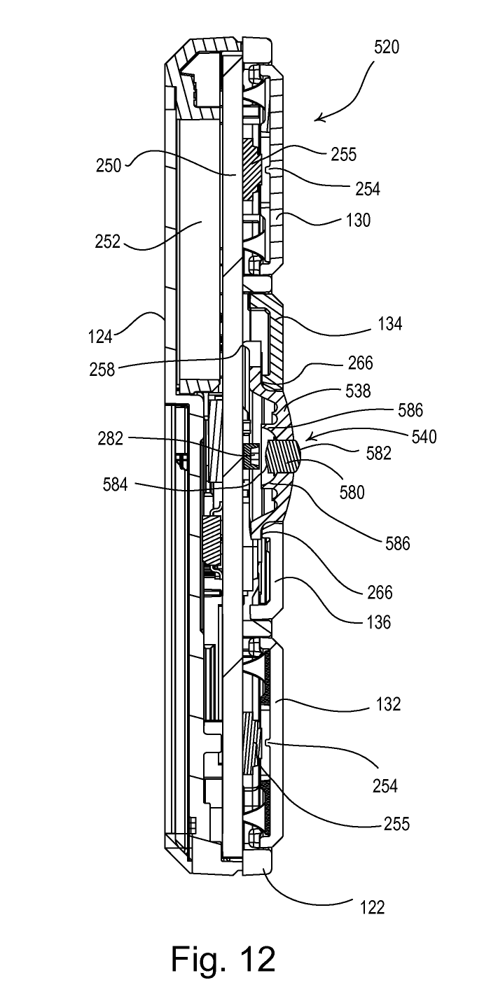

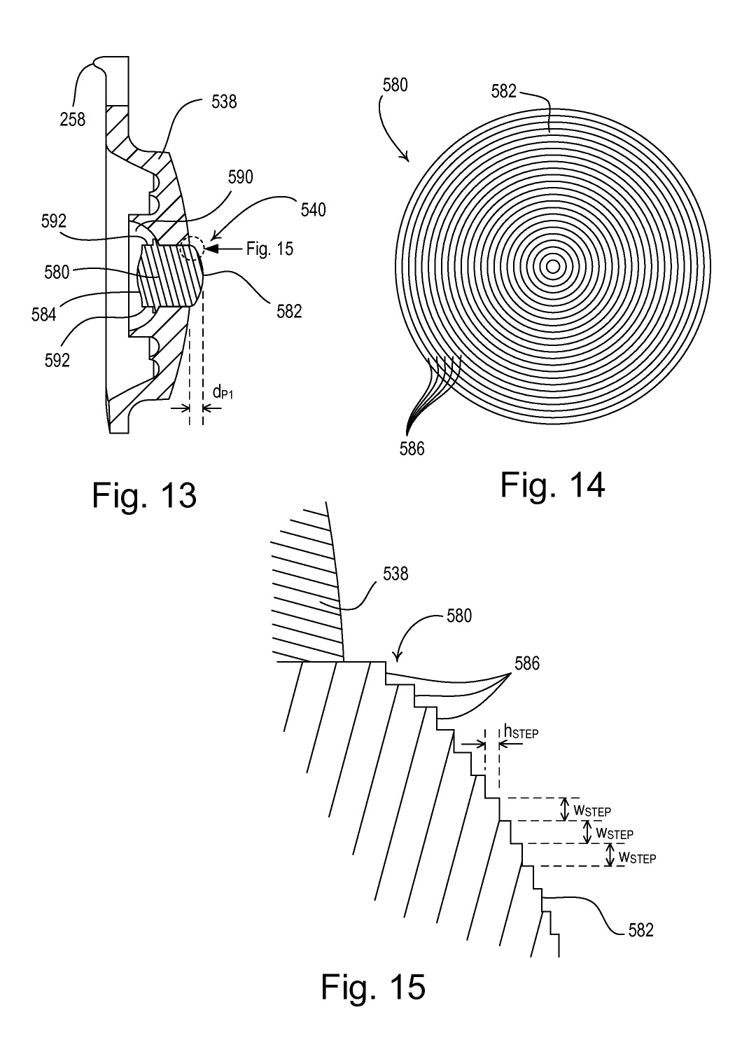

FIG. 12 is a left-side cross-sectional view of a remote control 520 taken through the center of the remote control. FIG. 13 is an enlarged cross-sectional view of a preset button 538 of the remote control 520 taken through the center of the preset button. As shown in FIGS. 12 and 13, the preset button 538 comprises a night light 540 having a cylindrical light pipe 580, which may be made from a clear material, such as, for example, clear polycarbonate. The light pipe 580 comprises a circular front surface 582 (e.g., having a diameter of approximately 0.1 inch) and an opposite rear surface 584 that is positioned adjacent a night-light LED (e.g., the night-light LED 282). The light pipe 580 operates to conduct light from the night-light LED 282 to the front surface 582, which has a convex shape extending outwards from the preset button 538 by a distance d_{P1} (e.g., approximately 0.025 inch) to improve the illumination of the night light 540 (as will be described in greater detail below). The area of the front surface 582 of the light pipe 580 and the intensity of the night-light LED 282 are optimized, such that the night light 540 is large enough and bright enough to see in a dark room. Because the light pipe 580 protrudes from the preset button 538 by the distance d_{P}, the light pipe also provides tactile feedback to help a user's finger locate the preset button to actuate the preset button (which will cause a lighting control device, such as the dimmer switch 110, to turn on or increase the intensity of the lighting load 104) when the remote control 520 is in a dark room.

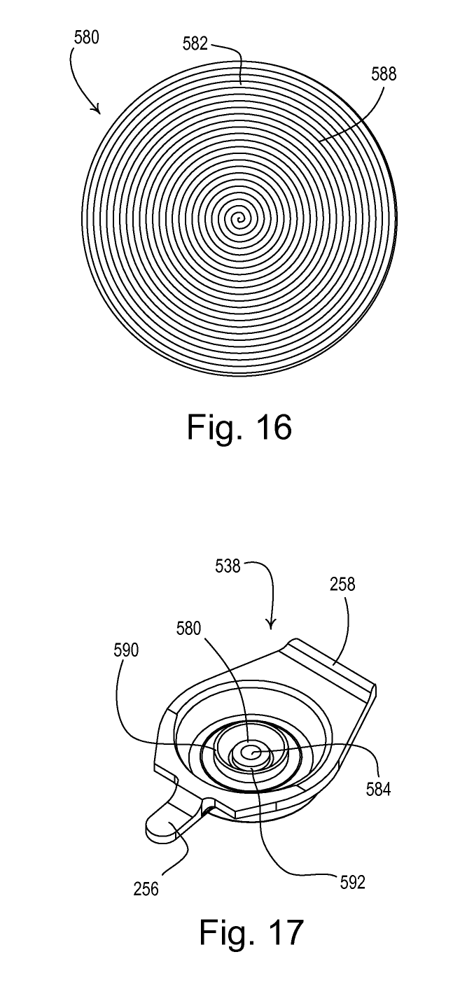

The front surface 582 of the light pipe 580 is textured to diffuse the light, to provide for a constant intensity of illumination across the front surface, and to improve off-angle viewing of the night light 540. FIG. 14 is an enlarged front view of the front surface 582 of the light pipe 580. FIG. 15 is a partial enlarged cross-sectional view of the front surface 582 of the light pipe 580 taken through the center of the light pipe (i.e., taken through the center of the preset button 538 as in FIG. 13). The front surface 582 of the light pipe 580 has a stepped profile formed by a plurality of concentric circular steps 586. As shown in FIG. 15, each of the steps 586 has an equal width w_{STEP} (e.g., approximately one one-thousandth of an inch), while each of the steps may have a different height h_{STEP} because of the convex shape of the front surface 582 of the light pipe 580. Since the front surface 582 of the light pipe 580 has a diameter of approximately 0.1 inch, the front surface may have approximately fifty concentric circular steps. Alternatively, the widths w_{STEP} of each of the steps 586 could each be different. The concentric circular steps 586 could be formed into the front surface 582 of the light pipe 580 during a machining processor or a molding process of the light pipe (i.e., the mold for the light pipe has equivalent steps). The front surface 582 of the light pipe 580 could alternatively comprise steps formed in a continuous helix shape 588 as shown in FIG. 16. For example, the helix shape could be formed on the front surface 582 of the light pipe 580 using a machining process or a molding process.

FIG. 17 is an enlarged bottom perspective view of the preset button 538 showing the rear surface 584 of the light pipe 580. The preset button 538 comprises a shroud 590 having a concave shape (i.e., bowl-shaped) and surrounding the rear surface 584 of the light pipe 580 that is adjacent the night-light LED 282. The shroud 590 is made from an opaque reflective material (e.g., white plastic). Light from the night-light LED 282 that does not shine on the rear surface 584 of the light pipe 580 is reflected off of the concave walls of the shroud 590 towards sides 592 of the light pipe. The light is then refracted towards the front surface 582 by the sides 592 of the light pipe 580, such that the night light 540 has a greater intensity than if the shroud 590 was not provided on the preset button 538.

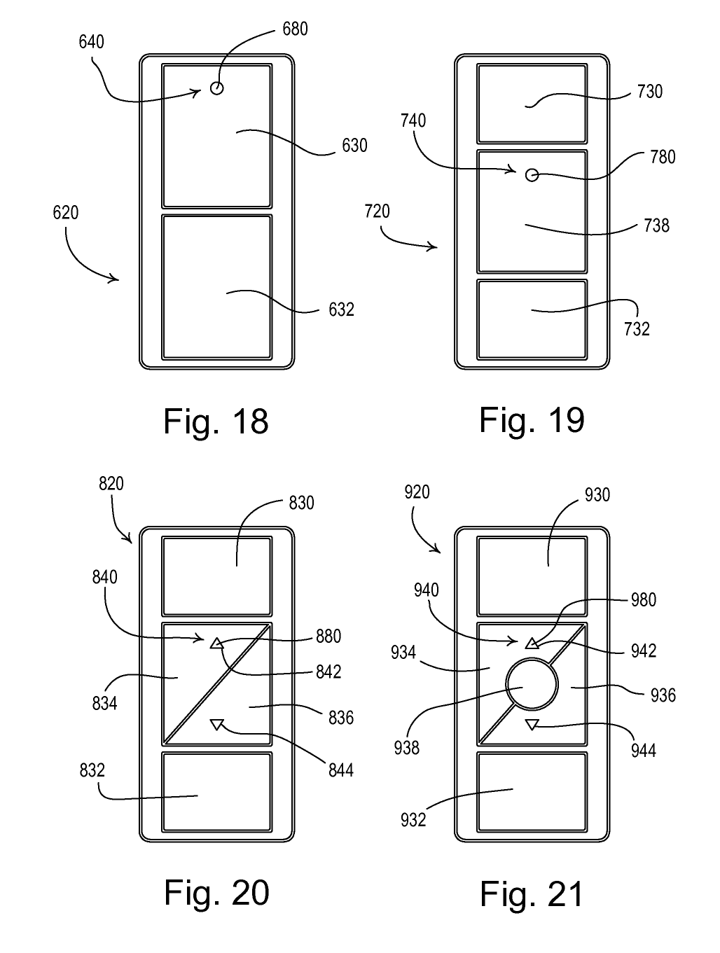

FIGS. 18 and 19 are front views of a two-button remote control 620 and a three-button remote control 720, respectively. The two-button remote control 620 simply comprises an on button 630 and an off button 632, while the three-button remote control 720 comprises an on button 730, an off button 732, and a preset button 738. The two-button remote control 620 comprises a circular night light 640 in the on button 630, and the three-button remote control 720 comprises a circular night light 740 in the preset button 738. The night lights 640, 740 comprise respective cylindrical light pipes 680, 780 (which may both be similar to the cylindrical light pipe 580 shown in FIG. 12). The front surfaces of the light pipes 680, 780 be textured (e.g., with a plurality of concentric circular steps as shown in FIG. 14). The light pipes 680, 780 may protrude from the on button 630 and the preset button 738, respectively, to provide tactile feedback to help the user locate the appropriate button to turn on a controlled lighting load. In addition, the on button 630 and the preset button 738 may have structures similar to the shroud 590 (shown in FIG. 13) on the bottom surfaces of the buttons to help reflect the light from the illuminating LEDs towards the respective light pipes 680, 780.

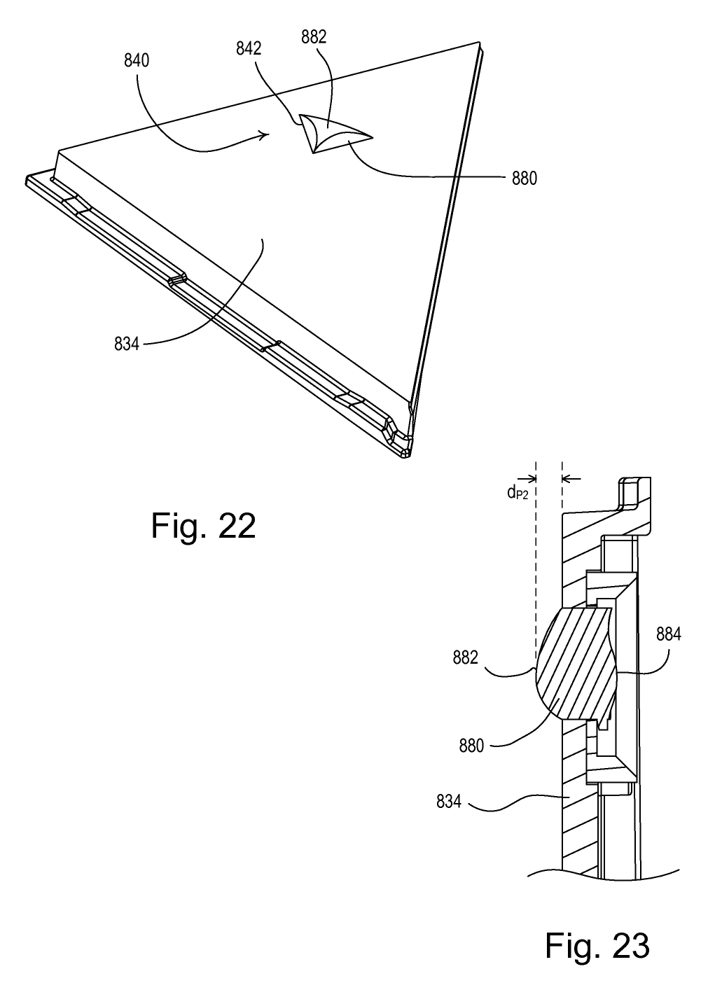

FIGS. 20 and 21 are front views of a four-button remote control 820 and a five-button remote control 920, respectively. The four-button remote control 820 and the five-button remote control 920 comprise respective on buttons 830, 930, off buttons 832, 932, raise buttons 834, 934, and lower buttons 836, 936. The five-button remote control 920 also comprises a preset button 938. The raise buttons 834, 934 and the lower buttons 836, 936 comprise respective triangular indicia 842, 942, 844, 944 for indicating the function of the raise and lower buttons (i.e., to respectively raise and lower the intensity of a controlled lighting load). The four-button remote control 820 and the five-button remote control 920 comprise respective triangular-shaped night lights 840, 940 located within the triangular indicia 842, 942 on the respective raise buttons 834, 934. Each of the night lights 840, 940 comprises a respective light pipe 880, 980 having a triangular front surface 882 (FIG. 22) that is surrounded by the respective triangular indicia 842, 942.

FIG. 22 is an enlarged perspective view of the raise button 834 of the four-button remote control 820 showing the light pipe 880 in greater detail. FIG. 23 is a right side cross-sectional view of the raise button 834 taken through the center of the light pipe 880. The light pipe 880 also comprises a rear surface 884 located adjacent a night-light LED (not shown) of the remote control 820. The front surface 882 of the light pipe 880 protrudes from the front surface of the raise button 834 by a distance d_{P2} (e.g., approximately 0.017 inch) to provide tactile feedback to help a user locate the raise button. The front surface 882 of the light pipe 880 is textured to appropriately illuminate the night light 840. For example, the front surface 882 of the light pipe 880 may have a stepped profile formed by a plurality of concentric triangular steps (similar to the circular steps 586 as shown in FIG. 14).

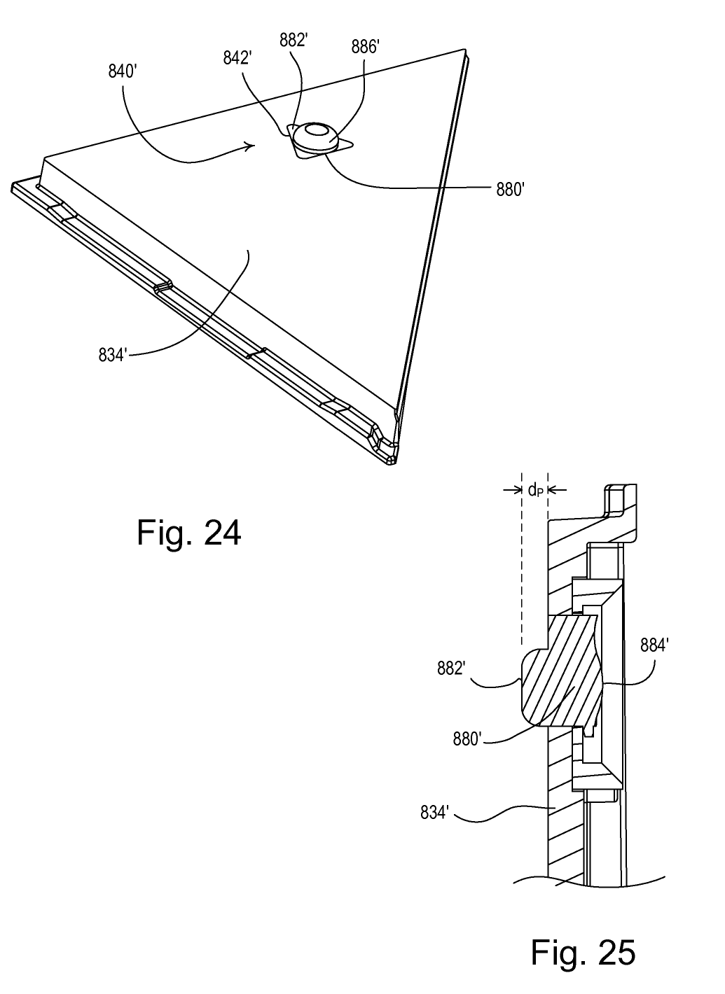

FIG. 24 is an enlarged perspective view of another example of a raise button 834′ and a light pipe 880′. FIG. 25 is a right side cross-sectional view of the raise button 834′ taken through the center of the light pipe 880′. The light pipe 880′ comprises a triangular front surface 882′ and a circular protuberance 886′ extending from the triangular front surface, so as to provide tactile feedback to help a user locate the raise button 834′. The circular protuberance 886′ may have a stepped profile formed by, for example, a plurality of concentric circular steps (as shown in FIG. 14).

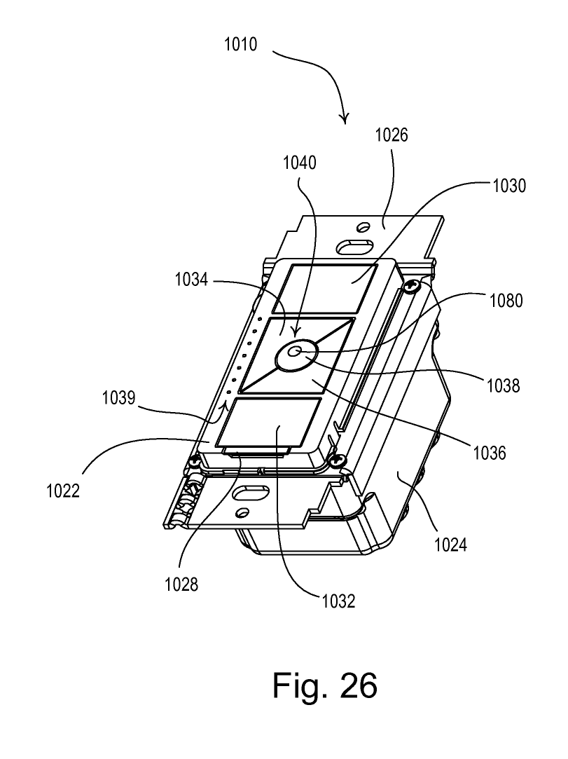

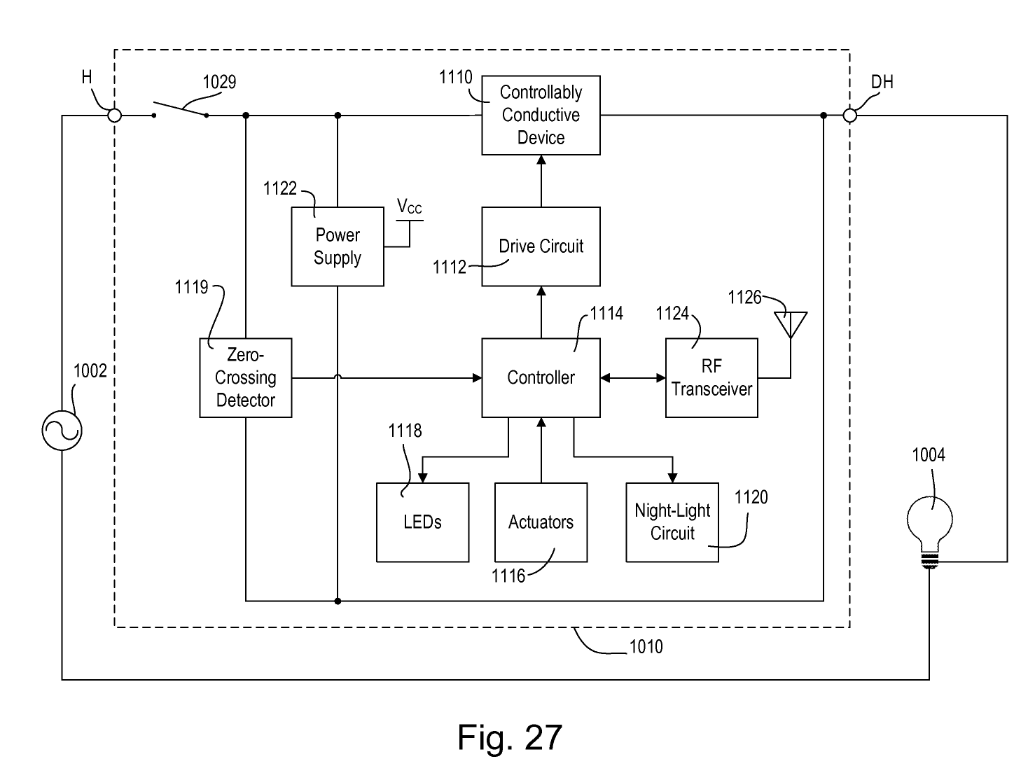

FIG. 26 is a perspective view of a wall-mountable load control device (e.g., a dimmer switch 1010) having a circular night light 1040. The dimmer switch 1010 comprises a bezel 1022, a rear enclosure 1024 for housing the electrical circuitry of the dimmer switch (which will be described in greater detail below with reference to FIG. 27), and a mounting yoke 1026 for mounting the load control device to an electrical wallbox. The dimmer switch 1010 is adapted to be coupled in series electrical connection between an AC power source 1002 (FIG. 27) and an electrical load, e.g., a lighting load 1004 (FIG. 27), for controlling the power delivered to the load. The dimmer switch 1010 comprises an on button 1030, an off button 1032, a raise button 1034, a lower button 1036, and a preset button 1038 to allow a user to control the electrical load. The dimmer switch 1010 may further comprise a linear array of visual indicators 1039 for providing feedback of the status of the load (e.g., the present intensity of the lighting load 1004). The dimmer switch 1010 also comprises an air-gap switch actuator 1028 that is able to open an internal air-gap switch 1029 (FIG. 24) to disconnect the lighting load 1004 from the AC power source 1002.

The night light 1040 is provided in the center of the preset button 1038 and comprises a cylindrical light pipe 1080. The light pipe 1080 comprises a circular, textured front surface having a convex shape extending outwards from the front surface of the preset button 1038 (similar to the light pipe 580 shown in FIG. 12). The front surface of the light pipe 1080 may have a stepped profile formed by a plurality of concentric circular steps (as shown in FIGS. 14 and 15) or formed by a continuous helix shape (as shown in FIG. 16). The light pipe 1080 protrudes from the front surface of the preset button 1038, so as to provide tactile feedback to help a user locate the preset button. Alternatively, the dimmer switch 1010 could have the appearance of any of the remote controls 620, 720, 820, 920 shown in FIGS. 18-21.

FIG. 27 is an example block diagram of the dimmer switch 1010. The dimmer switch 1010 comprises a hot terminal H that is adapted to be coupled to the AC power source 1002 and a dimmed hot terminal DH adapted to be coupled to the lighting load 1004. The dimmer switch 1010 comprises a controllably conductive device 1110 coupled in series electrical connection between the AC power source 1002 and the lighting load 1004 for control of the power delivered to the lighting load. The controllably conductive device 1110 may comprise any suitable type of bidirectional semiconductor switch, such as, for example, a triac, a field-effect transistor (FET) in a rectifier bridge, or two FETs in anti-series connection. The air-gap switch 1029 is coupled in series with the controllably conductive device 1110 and is opened and closed in response to actuations of the air-gap switch actuator 1028. When the air-gap switch 1029 is closed, the controllably conductive device 1110 is operable to conduct current to the load. When the air-gap switch 1029 is open, the lighting load 1004 is disconnected from the AC power source 1002.

The dimmer switch 1010 comprises a controller 1114 that is operatively coupled to a control input of the controllably conductive device 1110 via a gate drive circuit 1112 for rendering the controllably conductive device conductive or non-conductive to thus control the amount of power delivered to the lighting load 1004. The controller 1114 is, for example, a microprocessor, but may alternatively be any suitable processing device, such as a programmable logic device (PLD), a microcontroller, or an application specific integrated circuit (ASIC). The controller 1114 receives inputs from actuators 1116 (i.e., the on button 1030, the off button 1032, the raise button 1034, the lower button 1036, and the preset button 1038), and individually controls a plurality of LEDs 1118 to illuminate the linear array of visual indicators 1039. The controller 1114 receives a control signal representative of the zero-crossing points of the AC mains line voltage of the AC power source 1002 from a zero-crossing detector 1119. The controller 1114 is operable to render the controllably conductive device 1110 conductive and non-conductive at predetermined times relative to the zero-crossing points of the AC waveform using a phase-control dimming technique.

The dimmer switch 1010 further comprises a night-light circuit 1120 for illuminating the night light 1040 via the light pipe 1080. The night-light circuit 1120 may comprise any of the circuits shown in FIGS. 9A, 9B, and 9C, or a different circuit for conducting a constant LED current I_{LED} (e.g. having a magnitude of approximately 1.5 μA) through a night-light LED. The dimmer switch 1010 comprises a power supply 1122 for generating a direct-current (DC) supply voltage V_{CC} for powering the controller 1114, the night-light circuit 1120, and other low-voltage circuitry of the dimmer switch 1010. Since the dimmer switch 1010 does not have a connection to the neutral side of the AC power source 1002, the power supply 1122 is operable to conduct a charging current through the lighting load 1004 to generate the DC supply voltage V_{CC}. Some lighting loads 1004 may be susceptible to flickering and other undesirable behavior if the magnitude of the charging current conducted through the lighting load is too large. Since the magnitude of the constant LED current I_{LED} is very low, the charging current needed to generate the DC supply voltage V_{CC} is accordingly very low, and thus the night-light circuit 1120 allows the dimmer switch 1010 to provide the night light 1040 while avoiding flickering in the lighting load 1004.

The dimmer switch 1010 may also comprise a radio-frequency (RF) transceiver 1124 and an antenna 1126 for transmitting and receiving digital messages via RF signals. The controller 1114 may be operable to control the controllably conductive device 1110 to adjust the intensity of the lighting load 1004 in response to the digital messages received via the RF signals. The controller 1114 may also transmit feedback information regarding the amount of power being delivered to the lighting load 1004 via the digital messages included in the RF signals. Examples of wall-mounted RF dimmer switches are described in greater detail in commonly-assigned U.S. Pat. No. 5,982,103, issued Nov. 9, 1999, and U.S. Pat. No. 7,362,285, issued Apr. 22, 2008, both entitled COMPACT RADIO FREQUENCY TRANSMITTING AND RECEIVING ANTENNA AND CONTROL DEVICE EMPLOYING SAME; U.S. Pat. No. 5,905,442, issued May 18, 1999, entitled METHOD AND APPARATUS FOR CONTROLLING AND DETERMINING THE STATUS OF ELECTRICAL DEVICES FROM REMOTE LOCATIONS; and U.S. patent application Ser. No. 12/033,223, filed Feb. 19, 2008, entitled COMMUNICATION PROTOCOL FOR A RADIO-FREQUENCY LOAD CONTROL SYSTEM, the entire disclosures of all of which are hereby incorporated by reference. The RF transceiver 1124 could alternatively be implemented as an RF receiver for only receiving RF signals, an RF transmitter for only transmitting RF signals, an infrared receiver for receiving infrared (IR) signals, or a wired communication circuit adapted to be coupled to a wired communication link.

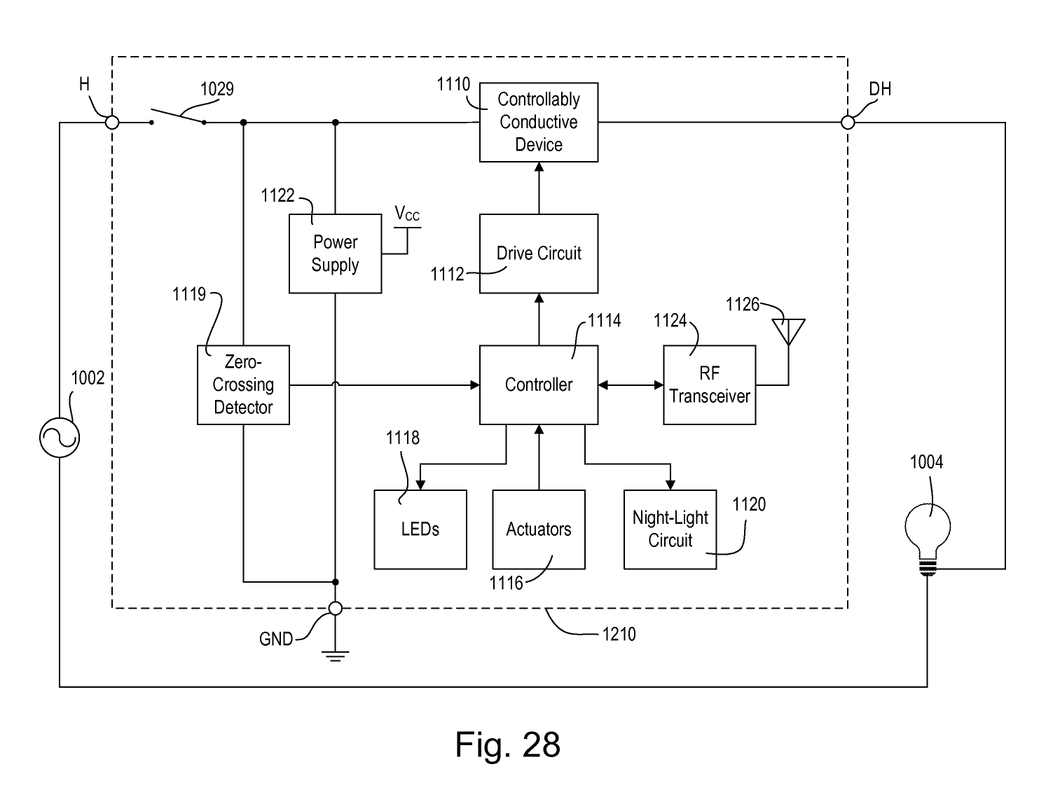

FIG. 28 is an alternative example block diagram of a dimmer switch 1210. The dimmer switch 1210 is very similar to the dimmer switch 1010 shown in FIG. 27. However, the dimmer switch 1020 has an earth ground terminal GND that is adapted to be coupled to earth ground. The zero-crossing detector 1119 and the power supply 1122 of the dimmer switch 1210 are coupled between the hot terminal H and the earth ground terminal GND (rather than the dimmed hot terminal DH). Accordingly, the power supply 1122 conducts the charging current through the earth ground terminal GND (rather than the lighting load 1004). The magnitude of the total current conducted through the earth ground terminal GND by the dimmer switch 1210 is limited by standards and regulations in most countries. Therefore, the night-light circuit 1120 allows the dimmer switch 1010 to provide the night light 1040 while conducting the charging current of the power supply 1122 through the earth ground terminal GND.

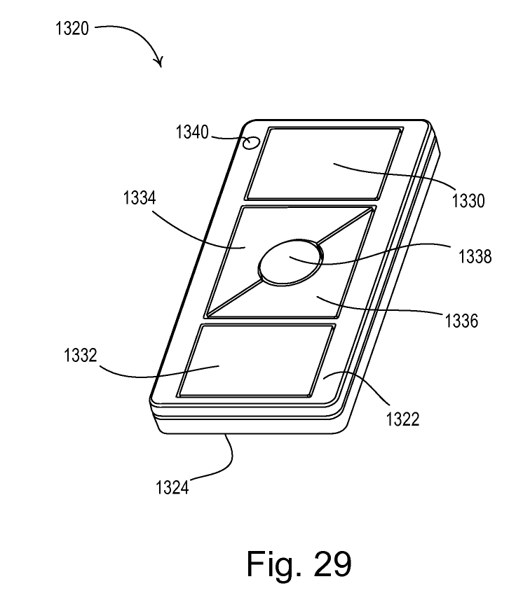

FIG. 29 is an enlarged perspective view of a remote control 1320 having a dual-function visual indicator 1340. The remote control 120 comprises a housing that includes a front enclosure portion 1322 and a rear enclosure portion 1324. The remote control 1320 further comprises a plurality of buttons (e.g., an on button 1330, an off button 1332, a raise button 1334, a lower button 1336, and a preset button 1338) provided in the front enclosure portion 1322. The visual indicator 1340 is located in the front enclosure portion 1322 next to the buttons 1330-1338. The visual indicator 1340 is illuminated brightly in response to the actuation of one of the buttons 1330-1338 to provide feedback to a user of the remote control 1320 and is illuminated dimly to provide a night light at other times. The visual indicator 1340 may comprise a light pipe similar to the light pipes 284, 580 shown in FIGS. 4, 12, 14, and 16.

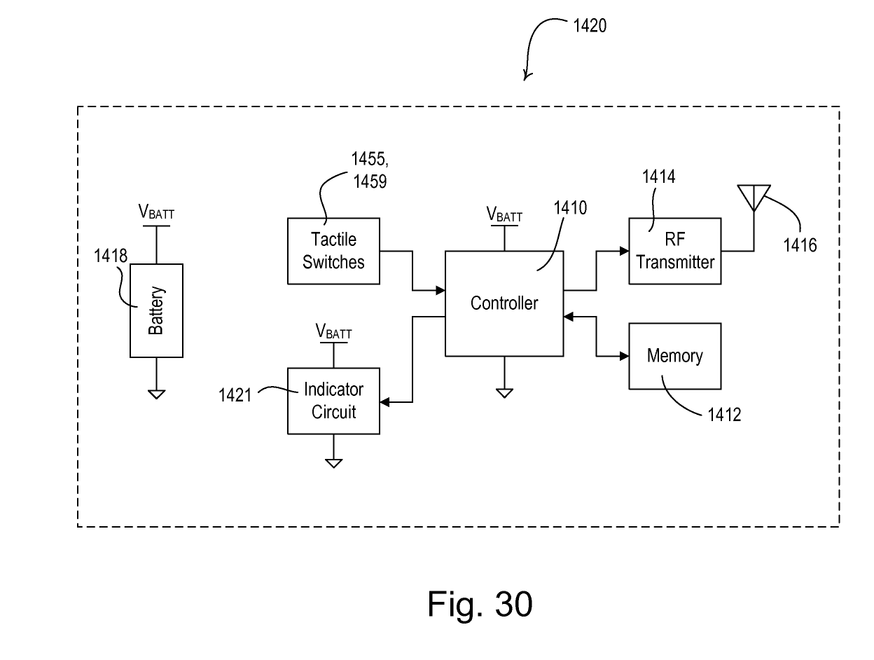

FIG. 30 is an example block diagram of a remote control 1420 (e.g., the remote control 1320 having the dual-function visual indicator 1340). The remote control 1420 comprises a controller 1410, which is operable to receive inputs from actuators of the remote control (e.g., the on button 1330, the off button 1332, the raise button 1334, the lower button 1336, and the preset button 1338 of the remote control 1320 shown in FIG. 29) via mechanical tactile switches 1455. The remote control 1420 comprises a memory 1412 for storage of the unique device identifier (e.g., a serial number) of the remote control. The remote control 1420 further includes an RF transmitter 1414 coupled to the controller 1410 and an antenna 1416. The controller 1410, the memory 1412, the RF transmitter 1414, and other electrical circuitry of the remote control 1420 are powered from a battery voltage V_{BATT} produced by a battery 1418.

The remote control 1420 further comprises a dual-function indicator circuit 1421 that includes an LED for illuminating a visual indicator of the remote control 1420 (e.g., the visual indicator 1340 of the remote control 1320 shown in FIG. 29). The controller 1410 is configured to control the indicator circuit 1421 in a first mode to illuminate the visual indicator 1340 to a first dim level to provide a night light. The controller 1410 is further configured to control the indicator circuit 1421 in a second mode to illuminate the visual indicator to a second level brighter than the first level to provide feedback to a user of the remote control 1420. For example, the controller 1410 may control the indicator circuit 1421 to blink the LED brightly while the user is pressing one of the buttons of the remote control 1420 to indicate that the RF transmitter 1414 is presently transmitting RF signals. The controller 1410 may be configured to enter a sleep mode (or state) when the indicator circuit 1421 is providing the night light in the first mode.

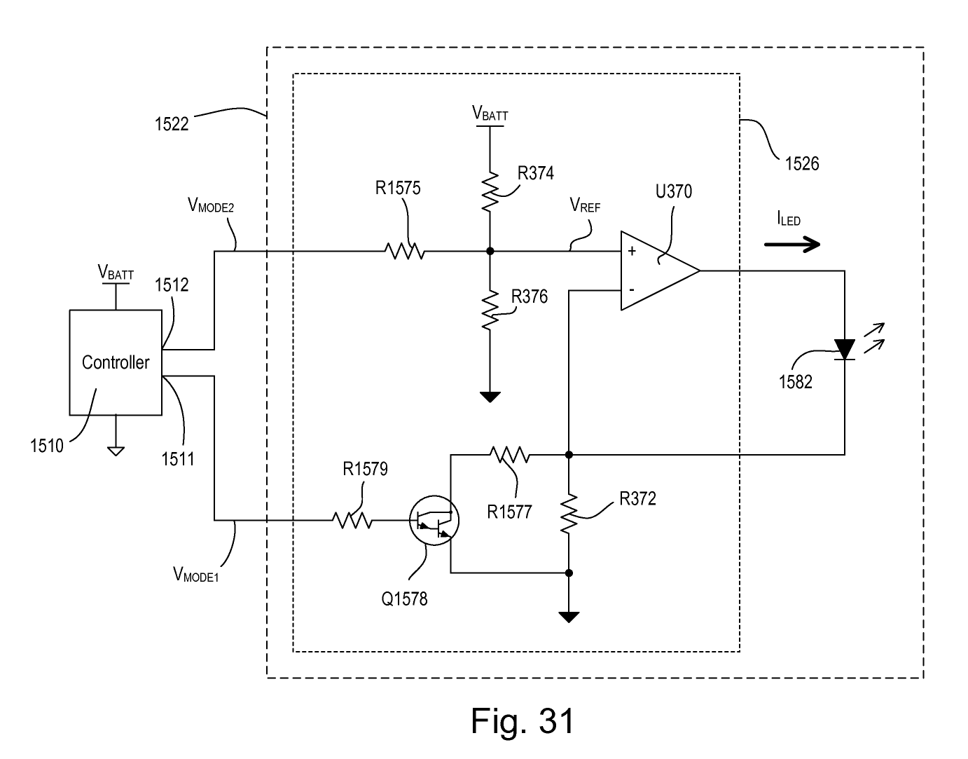

FIG. 31 is an example schematic diagram of a dual-function indicator circuit 1522 (e.g., the dual-function indicator circuit 1421 of the remote control 1420). The dual-function indicator circuit 1522 comprises a constant current source circuit 1526 for conducting a constant LED current I_{LED} through an LED 1582. The constant current source circuit 1526 has similar components to and operates in a similar manner as the constant current source circuit 326′ of the night-light circuit 322′ shown in FIG. 9B. However, the constant current source circuit 1526 of FIG. 31 is coupled to a controller 1510 (e.g., the controller 1410 of the remote control 1420), which is operable to control the operation of the constant current source circuit. The controller 1510 generates a first LED mode control signal V_{MODE1} at a first output pin 1511 and a second LED mode control signal V_{MODE2} at a second output pin 1512. The constant current source circuit 1526 comprises a resistor R1577 coupled in series with a controllable switch (e.g., a Darlington transistor Q1578). The series combination of the resistor R1577 and the transistor Q1578 is coupled in parallel with the resistor R372. The first LED mode control signal V_{MODE1} is coupled to the base of the transistor Q1578 via a resistor R1579 (e.g., having a resistance of approximately 100 kΩ). The second LED mode control signal V_{MODE2} is coupled to the junction of the resistors R374, R376 via a resistor R1575.

The controller 1510 generates the LED mode control signals V_{MODE1}, V_{MODE2} to control the indicator circuit 1522 in a first mode to illuminate the LED 1582 to a first dim level to provide a night light and in a second mode to illuminate the LED 1582 to a second level brighter than the first level to provide feedback. When the indicator circuit 1522 is providing the night light in the first mode, the magnitude of the LED current I_{LED} is approximately three orders of magnitude less than the normal operating current range of the LED 1582 (e.g., approximately 1.5 μA). In the second mode, the magnitude of the LED current I_{LED} may be within the normal operating current range of the LED 1582 (e.g., approximately 2 mA). When the controller 1510 drives the first LED mode control signal V_{MODE1} low towards circuit common while controlling the second output pin to a high impedance state, the transistor Q1578 is rendered non-conductive, such that only the resistor R372 is coupled in series with the LED 1582 and the constant current source circuit 1526 maintains the magnitude of the LED current I_{LED} approximately constant, e.g., at approximately 1.5 μA, to provide the night light.

To control the indicator circuit 1522 to the second mode, the controller 1510 drives both of the LED mode control signals V_{MODE1}, V_{MODE2} high towards the battery voltage V_{BATT}. When the controller 1510 drives the LED mode control signal V_{MODE} high, the transistor Q1578 is rendered conductive, such that the resistor R1577 is coupled in parallel and the magnitude of the LED current I_{LED} increases to approximately 2 mA. When the indicator circuit 1522 is operating in the second mode, the controller 1510 may alternately drive the second LED mode control signal V_{MODE2} low to control the magnitude of the LED current I_{LED} to approximately zero amps, and high to control the magnitude of the LED current I_{LED} to approximately 2 mA. Accordingly, the controller 1510 is able to pulse-width modulate the LED current I_{LED} to cause the LED 1582 to blink to provide the feedback when the indicator circuit 1522 is operating in the second mode. During the lifetime of the LED 1582, contaminates (e.g., moisture) may accumulate inside the enclosure of the LED. The increased magnitude of the LED current I_{LED} conducted through the LED 1582 during the second mode (e.g., within the normal operating current range of the LED) may burn off such debris.

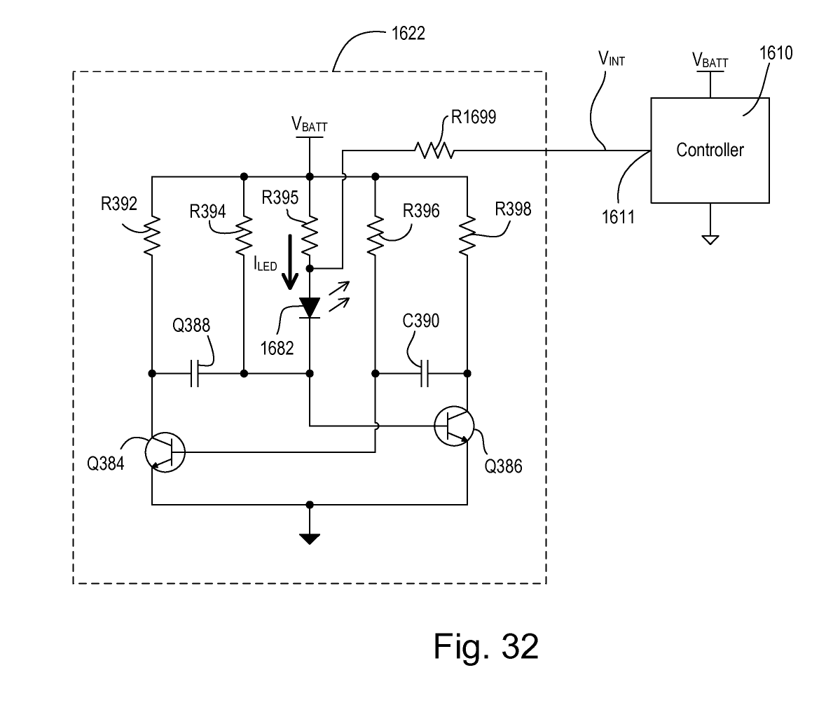

FIG. 32 is an example schematic diagram of a dual-function indicator circuit 1622 (e.g., the dual-function indicator circuit 1421 of the remote control 1420 shown in FIG. 30). The dual-function indicator circuit 1622 comprises an astable multivibrator circuit for conducting a pulse-width modulated LED current I_{LED} through an LED 1682 to illuminate the LED. The astable multivibrator circuit of the dual-function indicator circuit 1622 has similar components to and operates in a similar manner as the astable multivibrator circuit of the night-light circuit 322″ shown in FIG. 9C. However, the astable multivibrator circuit of the dual-function indicator circuit 1622 of FIG. 32 is coupled to a controller 1610 (e.g., the controller 1410 of the remote control 1420), which is operable to control the operation of the astable multivibrator circuit. The controller 1610 is configured to generate a LED intensity control signal V_{INT} at an output pin 1611, which is coupled to the junction of the LED 1682 and the resistor R395 via a resistor R1699 (e.g., having a resistance of approximately 200Ω).

The controller 1610 is configured to control the indicator circuit 1622 in a first mode in which the average magnitude of the LED current I_{LED} is three orders of magnitude less than the normal operating current range of the LED 1682 (e.g., approximately 2 μA) to thus illuminate the LED to a first dim level to provide a night light. Specifically, the controller 1610 is configured to control the indicator circuit 1622 into the first mode by setting the output pin 1611 to a high impedance state, in which the output pin has an impedance of, for example, approximately 10 MΩ or greater. The controller 1610 may be operable to enter a sleep mode when the indicator circuit 1622 is in the first mode. The controller 1610 is further configured to control the indicator circuit 1622 in a second mode in which the magnitude of the LED current I_{LED} is within the normal operating current range (e.g., approximately 2 mA) to thus illuminate the LED 1682 to a second level brighter than the first level to provide feedback. The controller 1610 is configured to control the indicator circuit 1622 into the second mode by driving the magnitude of the LED intensity control signal V_{INT} high towards the battery voltage V_{BATT}. The controller 1610 may also pulse-width modulate the LED intensity control signal V_{INT} to cause the LED 1682 to blink to provide the feedback when the indicator circuit 1622 is operating in the second mode.

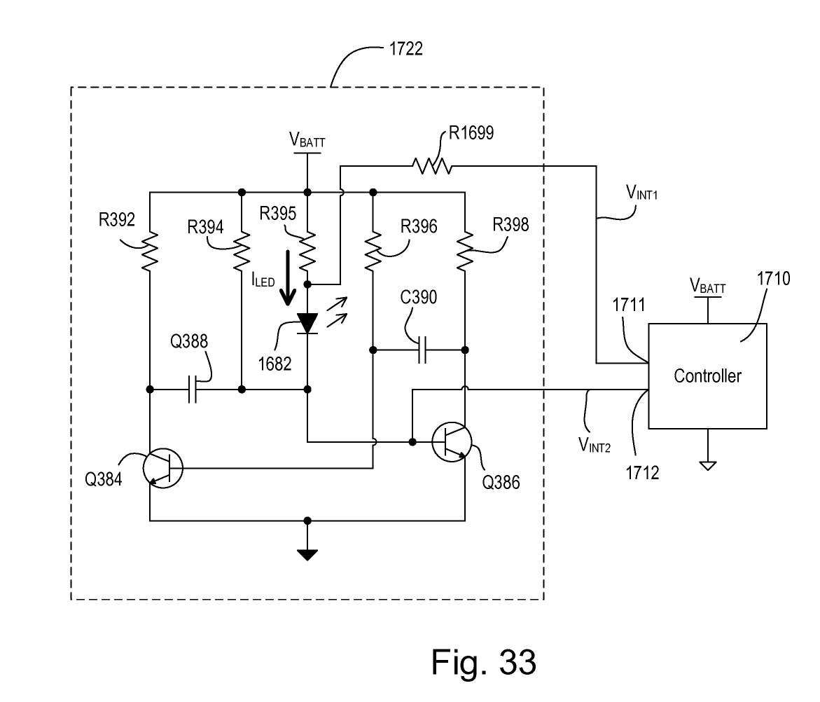

FIG. 33 is another example schematic diagram of a dual-function indicator circuit 1722 (e.g., the dual-function indicator circuit 1421 of the remote control 1420 shown in FIG. 30). The dual-function indicator circuit 1722 is very similar to the dual-function indicator circuit 1622 of FIG. 32. However, the astable multivibrator circuit of the dual-function indicator circuit 1722 of FIG. 33 is operable to receive two LED intensity control signals V_{INT1}, V_{INT2} from a controller 1710. The first LED intensity control signal V_{INT1} is generated by a first output pin 1711 of the controller 1710, which is coupled to the junction of the LED 1682 and the resistor R395 via a resistor R1699 (e.g., having a resistance of approximately 200Ω). The second LED intensity control signal V_{INT2} is generated by a second output pin 1712 of the controller 1710, which is coupled to the base of the second transistor Q386 of the astable multivibrator circuit.

The controller 1710 is configured to control the indicator circuit 1722 in a first mode in which the average magnitude of the LED current I_{LED} is an order of magnitude less than the normal operating current range of the LED 1682 (e.g., approximately 2 μA) to thus illuminate the LED to a first dim level to provide a night light. Specifically, the controller 1710 is configured to control the indicator circuit 1722 into the first mode by setting the output pins 1711, 1712 each to a high impedance state, in which each output pin has an impedance of, for example, approximately 10 MΩ or greater. The controller 1710 may be operable to enter a sleep mode when the indicator circuit 1722 is in the first mode. The controller 1710 is further configured to control the indicator circuit 1722 in a second mode in which the magnitude of the LED current I_{LED} is within the normal operating current range (e.g., approximately 2 mA) to thus illuminate the LED 1682 to a second level brighter than the first level to provide feedback. The controller 1710 is configured to control the indicator circuit 1722 into the second mode by simultaneously driving the magnitude of the first LED intensity control signal V_{INT1} high towards the battery voltage V_{BATT} and the magnitude of the second LED intensity control signal V_{INT2} low towards circuit common. The controller 1610 may also pulse-width modulate the first and second LED intensity control signals V_{INT1}, VINT2 to cause the LED 1682 to blink to provide the feedback when the indicator circuit 1722 is operating in the second mode.

While the present invention has been described with reference to the remote controls 120, 320, 420, 520, 620, 720, 820, 920, 1320, 1420 and the dimmer switches 1010, 1210, the concepts of the present invention could be used to provide a night light on another type of control device such as, for example, a temperature control device for controlling a heating and/or cooling system; a sensor, such as, an occupancy sensor, a vacancy sensor, a daylight sensor, or a temperature sensor; a doorbell; or a motorized window treatment (having a motor drive unit for controlling a motor to adjusting a covering material). In addition, while the night lights 140, 440, 540, 640, 740, 840, 940 described herein are displaced on actuators of control devices (e.g., on the preset actuator 138 of the remote control 120), the night lights could alternatively be located on structures other than actuators, for example, on the front enclosure portion 122 of the remote control 120 next to the open button 130.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A control device for use in a load control system for controlling an electrical load receiving power from a power source, the control device comprising:
a visual indicator;
an indicator circuit comprising an LED for illuminating the visual indicator, the indicator circuit operable to conduct an LED current through the LED to illuminate the LED, the LED having a normal operating current range; and
a controller coupled to the indicator circuit, the controller configured to control the indicator circuit in a first mode to illuminate the LED to a first level to provide a night light, the LED current in the first mode having a magnitude below the normal operating current range;
wherein the controller is configured to control the indicator circuit in a second mode to illuminate the LED to a second level greater than the first level to provide feedback to a user of the control device, the LED current in the second mode having a magnitude within the normal operating current range of the LED.

2. The control device of claim 1, further comprising:
an actuator, the controller responsive to actuations of the actuator.

3. The control device of claim 2, wherein the visual indicator is provided in a front surface of the actuator.

4. The control device of claim 3, further comprising:
a light pipe for conducting the light from the LED to the visual indicator at the front surface of the actuator;
wherein the light pipe is cylindrical and has a textured, circular front surface having a convex shape extending outwards from the front surface of the actuator.

5. The control device of claim 4, wherein the front surface of the light pipe has a stepped profile formed by a plurality of concentric circular steps.

6. The control device of claim 4, wherein the front surface of the light pipe has steps formed in a continuous helix shape.

7. The control device of claim 2, further comprising:
an enclosure portion in which the actuator is provided;
wherein the visual indicator is located in the enclosure portion adjacent the actuator.

8. The control device of claim 2, further comprising:
a wireless transmitter operatively coupled to the controller;
wherein the controller is operable to transmit a digital message in response to actuations of the actuator.

9. The control device of claim 2, wherein the controller is configured to pulse-width modulate the LED current to blink the visual indicator to provide feedback when the actuator is actuated.

10. The control device of claim 1, further comprising:
a battery for producing a battery voltage to power the controller and the indicator circuit.

11. The control device of claim 10, wherein the LED current conducted through the LED by the indicator circuit in the first mode has a constant magnitude.

12. The control device of claim 11, wherein the controller is coupled to the indicator circuit for adjusting the constant magnitude of the LED current.

13. The control device of claim 12, wherein the controller is further configured to pulse-width modulate the LED current.

14. The control device of claim 13, wherein the indicator circuit comprises an op amp constant current source circuit.

15. The control device of claim 13, wherein the indicator circuit comprises a multivibrator circuit in which the LED is electrically connected.

16. The control device of claim 10, wherein the control device comprises a battery-powered remote control.

17. The control device of claim 1, wherein the LED current has a constant magnitude of a few μA in the first mode, and has a peak magnitude of approximately 2 mA in the second mode.

18. The control device of claim 17, wherein the LED current has a constant magnitude of approximately 1.5 μA or less in the first mode.

19. The control device of claim 1, wherein the controller is configured to enter a sleep mode when the LED is illuminated to the first level in the first mode.

20. The control device of claim 1, wherein the controller is configured to pulse-width modulate the LED current in the second mode to cause the LED to blink to provide feedback to the user.
